(19) United States
(12) Patent Application Publication
(10) Pub. No.: US 2008/0290822 A1
(43) Pub. Date: Nov. 27, 2008

(54) ITEM AND METHOD FOR WIRELESSLY POWERING THE ITEM

(76) Inventors: Charles E. Greene, Cabot, PA (US); G. Randolph Maruschock, Trafford, PA (US); Michael Thomas McElhinny, Port Vue, PA (US); Daniel W. Harrist, Carnegie, PA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/125,516

(22) Filed: May 22, 2008

Related U.S. Application Data
(60) Provisional application No. 60/931,414, filed on May 23, 2007.
(60) Provisional application No. 60/931,481, filed on May 23, 2007.

(51) Int. Cl. H05B 37/00; H02J 17/00

(52) U.S. Cl. 315/363; 307/149

(57) ABSTRACT

A method and an apparatus according to an embodiment include a member, a first elongate member, and a second elongate member. Each of the first elongate member and the second elongate member are coupled to the member. A receiver configured to convert an electromagnetic wave to a DC power is disposed on the member. A first light-emitting device and a second light-emitting device are disposed on the first elongate member and on the second elongate member, respectively. Each of the light-emitting devices is configured to operate based on the DC power from the receiver. In another embodiment, a second receiver configured to convert an electromagnetic wave to a DC power can be disposed on one of the elongate members. In such embodiment, the light-emitting devices are configured to operate based on the DC power from the first and second receivers.

### CROSS-REFERENCE AND RELATED APPLICATIONS

This application claims priority to U.S. Provisional Application Ser. No. 60/931,414, entitled “Item and Method for Wirelessly Powering the Item,” filed May 23, 2007, and U.S. Provisional Application Ser. No. 60/931,481, entitled “Smart Receiver and Method,” filed May 23, 2007; each of which is incorporated herein by reference in its entirety.

This application is related to U.S. Pat. No. 7,027,311, entitled “Method And Apparatus For A Wireless Power Supply,” filed Oct. 15, 2004; U.S. patent application Ser. No. 11/356,892, entitled “Method, Apparatus And System For Power Transmission,” filed Feb. 16, 2006; U.S. patent application Ser. No. 11/438,508, entitled “Power Transmission Network,” filed May 22, 2006; U.S. patent application Ser. No. 11/447,412, entitled “Powering Devices Using RF Energy Harvesting,” filed Jun. 6, 2006; U.S. patent application Ser. No. 11/481,499, entitled “Power Transmission System,” filed Jul. 6, 2006; U.S. patent application Ser. No. 11/584,983, entitled “Method And Apparatus For High Efficiency Rectification For Various Loads,” filed Oct. 23, 2006; U.S. patent application Ser. No. 11/601,142, entitled “Radio-Frequency (RF) Power Portal,” filed Nov. 17, 2006; U.S. patent application Ser. No. 11/651,818, entitled “Pulse Transmission Method,” filed Jan. 10, 2007; U.S. patent application Ser. No. 11/699,148, entitled “Power Transmission Network And Method,” filed Jan. 29, 2007; U.S. patent application Ser. No. 11/705,303, entitled “Implementation Of An RF Power Transmitter And Network,” filed Feb. 12, 2007; U.S. patent application Ser. No. 11/494,108, entitled “Method And Apparatus For Implementation Of A Wireless Power Supply,” filed Jul. 27, 2009; U.S. patent application Ser. No. 11/811,081, entitled “Wireless Power Transmission,” filed Jun. 8, 2007; U.S. patent application Ser. No. 11/881,203, entitled “RF Power Transmission Network And Method,” filed Jul. 26, 2007; U.S. patent application Ser. No. 11/897,346, entitled “Hybrid Power Harvesting And Method,” filed Aug. 30, 2007; U.S. patent application Ser. No. 11/897,345, entitled “RF Powered Specialty Lighting, Motion, Sound,” filed Aug. 30, 2007; U.S. patent application Ser. No. 12/006,547, entitled “Wirelessly Powered Specialty Lighting, Motion, Sound,” filed Jan. 3, 2008; U.S. patent application Ser. No. 12/005,696, entitled “Powering Cell Phones and Similar Devices Using RF Energy Harvesting,” filed Dec. 28, 2007; U.S. patent application Ser. No. 12/005,737, entitled “Implementation of a Wireless Power Transmitter and Method,” filed Dec. 28, 2007; and U.S. patent application Ser. No. 12/048,529, entitled “Multiple Frequency Transmitter, Receiver, and Systems Thereof,” filed Mar. 14, 2008. The above-identified U.S. patent and U.S. patent applications are hereby incorporated herein by reference in their entirety.

### BACKGROUND

The disclosed systems and methods relate generally to transmitting power wirelessly and more particularly to wirelessly powering an illumination device.

Certain illumination devices, such as light sticks, for example, have become popular for use in indoor and outdoor lighting. Illumination devices are also used to provide certain settings with a desirable aesthetic or decorative appearance. An important consideration with these devices is the ability of a user to provide power for the operation of these devices. One known solution is to use wires to bring power to the illumination device. Wires, however, can make an illumination device cumbersome to use in some outdoors settings. For example, in a flower garden, wires used to provide power to an illumination device are routed through plants or buried underground to hide them from view and/or to avoid tampering or damage. Such wires can limit some indoor uses as well. For example, it is not desirable to place an illumination device inside a vase or a decorative container and have the wires to power the illumination device run over the top of the vase.

Another solution currently employed is to use batteries to power an illumination device, thus eliminating the need for wires. Replacing dead batteries, however, can be burdensome and/or prohibitively costly. While some outdoor lighting devices use solar cells to recharge batteries, the unpredictability of weather conditions reduces the ability to control the charge level in a battery, thus limiting the lighting level and/or the operating time of the illumination device. Moreover, the size and placement of the solar cell could make this solution less attractive than burring a wire underground. Additionally, solar cells that recharge an illumination device could be impractical for indoor applications.

Thus, a need exists for illumination devices that operate without wires to provide power to the illumination device and that receive power in a reliable manner such that the illumination devices are more versatile to operate, install, and/or maintain.

### SUMMARY

A method and an apparatus according to an embodiment include a member, a first elongate member, and a second elongate member. Each of the first elongate member and the second elongate member are coupled to the member. A receiver configured to convert an electromagnetic wave to a DC power is disposed on the member. A first light-emitting device and a second light-emitting device are disposed on the first elongate member and on the second elongate member, respectively. Each of the light-emitting devices is configured to operate based on the DC power from the receiver. In another embodiment, a second receiver configured to convert an electromagnetic wave to a DC power can be disposed on one of the elongate members. In such embodiment, the light-emitting devices are configured to operate based on the DC power from the first and second receivers.

### BRIEF DESCRIPTION OF THE DRAWINGS

FIG. 1 is a diagram illustrating a system for wireless transmission of power, according to an embodiment.

FIG. 2 is a diagram illustrating a transmitter module, according to an embodiment.

FIG. 3 is a diagram illustrating a receiver module, according to an embodiment.

FIGS. 4A and 4B each depicts an illumination device having a trunk, multiple branches, light-emitting devices disposed on the branches, and a receiver module at the base of the trunk, according to an embodiment.

FIG. 4C illustrates an illumination device having multiple branches, light-emitting devices in the branches, and a receiver module at the base of one of the branches, according to an embodiment.

FIGS. 5A and 5B each depicts a converter module configured to output DC power to multiple light-emitting devices, according to an embodiment.

FIGS. 6A and 6B each depicts an illumination device having a receiver module at each branch and at the base of the trunk, according to an embodiment.

FIG. 7 is a diagram illustrating multiple converter modules configured to output DC power to multiple light-emitting devices, according to an embodiment.

FIG. 8 is a diagram illustrating a transmitter module, a container having a receiver module, and an illumination device, according to an embodiment.

FIG. 9 is a diagram illustrating an illumination device having receiver modules disposed on unlit branches, according to an embodiment.

FIG. 10 is a block diagram illustrating multiple converter modules configured to output DC power in a power bus to multiple light-emitting devices, according to an embodiment.

FIG. 11 is a diagram illustrating an illumination device having a dedicated receiver module for each light-emitting device, according to an embodiment.

FIG. 12 is a block diagram illustrating multiple converter modules each configured to output a DC power to a light-emitting device, according to an embodiment.

FIG. 13 is a diagram illustrating expanded views of an illumination device showing a light-emitting device attached to a branch and a receiver module attached to a base of a trunk, according to an embodiment.

FIGS. 14 and 15 each depicts an illumination device having multiple light-emitting devices wired to a receiver module, according to an embodiment.

FIG. 16 is a diagram illustrating an illumination device having a single branch and a receiver module at the base of the branch, according to an embodiment.

FIG. 17 is a flow chart illustrating a method according to an embodiment.

FIG. 18 is a block diagram of a receiver module, according to an embodiment.

FIG. 19 is a schematic diagram of a receiver module, according to an embodiment.

FIGS. 20-21 are flow charts illustrating a method for operating an illumination device, according to an embodiment.

### DETAILED DESCRIPTION

In an embodiment, an apparatus includes a member, a first elongate member, a second elongate member, a receiver, a first light-emitting device, and a second light-emitting device. Each of the first elongate member and the second elongate member are coupled to the member. The receiver is configured to convert an electromagnetic wave to a DC power. The receiver is disposed on the member. Each of the first light-emitting device and the second light-emitting device is configured to operate based on the DC power from the receiver. The first light-emitting device is disposed on the first elongate member and the second light-emitting device is disposed on the second elongate member. The apparatus can further include a second receiver configured to convert an electromagnetic wave to a DC power. The second receiver is disposed on the first elongate member. The first light-emitting device and the second light-emitting device are configured to operate based on at least one of the DC power from the receiver or the DC power from the second receiver.

In another embodiment, an apparatus includes a container, a first elongate member, a second elongate member, and a light-emitting device. The container includes a receiver configured to convert an electromagnetic wave to a DC power. The first elongate member has a first end portion that is coupled to the container. The second elongate member is coupled to a second end portion of the first elongate member opposite the first end portion. The light-emitting device is configured to operate based on the DC power from the receiver. The light-emitting device is disposed on the second elongate member.

In another embodiment, an apparatus includes a first elongate member, a second elongate member, a receiver, and a light-emitting device. The second elongate member is coupled to the first elongate member. The receiver is configured to convert an electromagnetic signal to a DC power. The receiver is disposed on the first elongate member. The light-emitting device is configured to operate based on the DC power from the receiver. The light-emitting device is disposed on the second elongate member. The apparatus can further include a third elongate member, a second receiver, and a driver. The third elongate member is coupled to the first elongate member. The second receiver is configured to convert an electromagnetic signal to a DC power. The second receiver is disposed on the third elongate member, the DC power from the receiver and the DC power from the second receiver are configured to a DC power bus. The driver is configured to adjust the DC power bus to provide at least one of a substantially constant current or a substantially constant voltage to the light-emitting device.

In another embodiment, an apparatus includes a first elongate member, a second elongate member, a receiver, a first light-emitting device, and a second light-emitting device. The first end portion of the first elongate member is coupled to a first end portion of the second elongate member. The receiver is configured to convert an electromagnetic wave to a DC power. The receiver is disposed on the first elongate member. Each of the first light-emitting device and the second light-emitting device is configured to operate based on the DC power from the receiver. The first light-emitting device is disposed on a second end portion of the first elongate member opposite the first end portion of the first elongate member. The second light-emitting device is disposed on a second end portion of the second elongate member opposite a first end portion of the second elongate member.

In another embodiment, a method includes receiving an electromagnetic wave, converting the electromagnetic wave to a DC power, providing the DC power to a light-emitting diode, and disabling the operation of the light-emitting diode based on at least one of a predetermined illumination level, an appropriate control signal, or an expiration of a time period.

In another embodiment, a kit includes a transmitter, a receiver, and an elongate member. The transmitter is configured to generate an electromagnetic wave. The receiver is configured to convert the electromagnetic wave to a DC power. The elongate member has a first end portion and a second end portion opposite the first end portion. The receiver is disposed on the first end portion of the elongate member. A light-emitting device is disposed on the second end portion of the elongate member. The light-emitting device is configured to operate based on the DC power from the receiver.

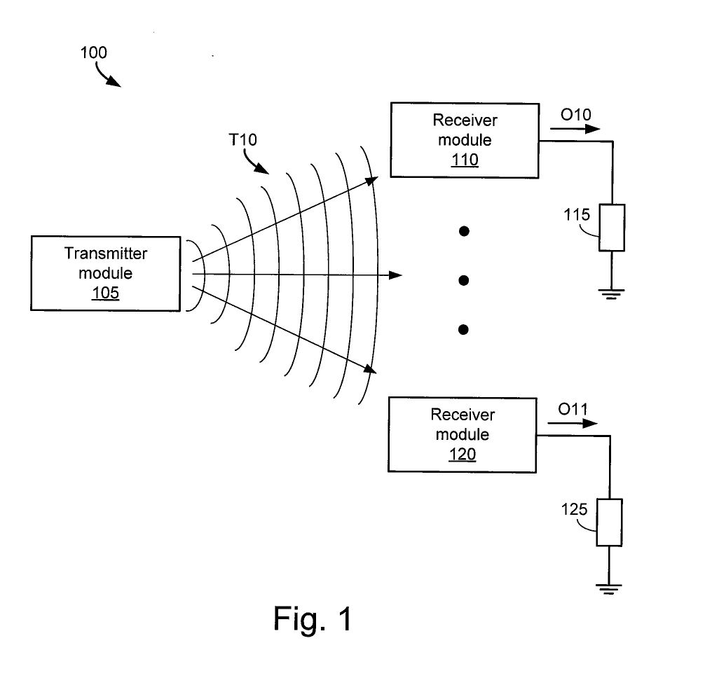

FIG. 1 is a diagram illustrating a wireless power transmission system 100 for wireless transmission of power. The wireless power transmission system 100 includes a transmitter module 105 and one or more receiver modules, such as receiver modules 110 and 120, for example. Each receiver module is coupled to a device. For example, the receiver module 110 is coupled to a device 115, and the receiver module 120 is coupled to a device 125. The devices 115 and 125 can be light-emitting devices such as light-emitting diodes (LEDs), for example. In some instances, the devices 115 and 125 can be devices other than light-emitting devices, such as, for example, devices having periods of activity and periods of inactivity (e.g., microspeakers).

The transmitter module 105 is configured to generate an output T10 having one or more electromagnetic waves. The electromagnetic waves in the output T10 have a frequency band within the radio frequency (RF) spectrum, for example. The transmitter module 105 can be software-based (e.g., set of instructions executable at a processor, software code) and/or hardware-based (e.g., circuit system, processor, application-specific integrated circuit (ASIC), field programmable gate array (FPGA)). The transmitter module 105 can include an antenna (not shown) to transmit the output T10.

Each of the receiver modules 110 and 120 is configured to receive at least a portion of the output T10 from the transmitter 105. The receiver modules 110 and 120 are each configured to convert the received portion of the output T10 to a DC power. Said another way, the receiver modules 110 and 120 can convert power received from the electromagnetic wave to a DC power (e.g., RF-to-DC conversion). Each of the receiver modules 110 and 120 can be software-based (e.g., set of instructions executable at a processor, software code) and/or hardware-based (e.g., circuit system, processor, ASIC, FPGA). The receiver modules 110 and 120 each include an antenna (not shown) to receive at least a portion of the output T10 from the transmitter 105. In some embodiments, the receiver module 110 and/or the receiver module 120 can be configured to receive an electromagnetic wave from a source other than the transmitter 105 and to convert power associated with the electromagnetic wave to a DC power.

The receiver module 110 is configured to produce an output O10 having an associated DC power. The receiver module 120 is configured to produce an output O11 having an associated DC power. The receiver modules 110 and 120 are configured to provide the outputs O10 and O11 to the devices 115 and 125, respectively. The DC power associated with the output O10 and output to the device 115 can be sufficient to allow operation of the device 115 without further power from another power source. Similarly, the DC power associated with the output O11 and output to the device 125 can be sufficient to allow operation of the device 125 without further power from another power source.

The location and/or transmission direction of the transmitter module 105 with respect to the receiver modules 110 and 120 can be such that the power wirelessly transferred from the transmitter module 105 to the receiver modules 110 and 120 via the output T10 is optimized or maximized. Moreover, a maximum distance or range between the transmitter module 105 and any one receiver module results when the receiver module is able to produce sufficient DC power to operate a device while the receiver module is placed as far away from the transmitter module 105 as possible. When a device (e.g., 115 or 125) is primarily stationary, the distance between the transmitter module 105 and the receiver module (e.g., 110 or 120) can be fixed. This fixed distance between the transmitter module 105 and a receiver module allows the receiver module to better control the DC power used to operate a device because the power wirelessly transferred from the transmitter module 105 to the receiver module is substantially constant and/or predictable.

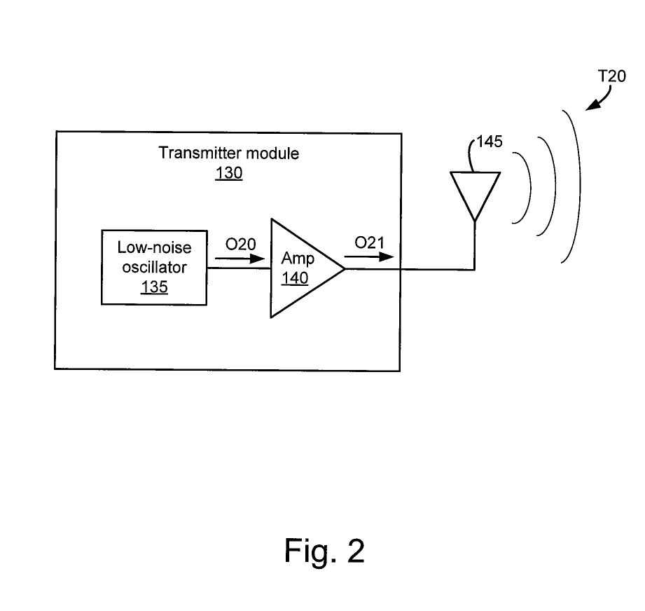

FIG. 2 is a diagram illustrating a transmitter module 130, according to an embodiment. The transmitter module 130 includes a low-noise oscillator 135, an amplifier (Amp) 140, and an antenna 145. The low-noise oscillator 135 is configured to generate an output O20 having narrow frequency band (i.e., quasi-single-frequency) within the RF spectrum. In this regard, the output O20 can be represented by a center frequency within the narrow frequency band. The transmitter module 130 can include circuitry (not shown) to adjust and/or control the output O20 (e.g., adjust the center frequency for temperature variations).

The amplifier 140 is configured to produce an output O21 by amplifying an amplitude of the output O20. For example, the amplification provided by the amplifier 140 increases the power associated with the center frequency of the output O20. The transmitter module 130 can include circuitry (not shown) to adjust and/or control the amplification provided by the amplifier 140. The transmitter module 130 is configured to wirelessly transmit the output O21 via the antenna 145 as output T20. The output T20 can include an electromagnetic wave having a frequency band and a power level that substantially corresponds to that of output O21.

In one example, the low-noise oscillator 135 is configured to produce an output O20 having a nominal frequency of 905.8 MHz. The amplifier 140 is configured to amplify the output O20 to an output O21 having 1 Watt of power. The antenna 145 is a patch antenna constructed on a 5-inch-by-5-inch printed circuit board (PCB) and having a gain of 3.8 (5.8 dBi). The transmitter 130 is configured to operate from a 3.3 Volt source (not shown) provided by an alternating-current-to-direct-current (AC-to-DC) converter (not shown) coupled to a power outlet. In this example, the transmitter 130 is located within approximately 8 feet from a receiver module and can transmit sufficient power to the receiver module such that the receiver module can provide DC power to operate at least one light-emitting diode (LED). In this regard, it is desirable to place the receiver module within a 3 decibels (dB) half-power beamwidth of the antenna of the transmitter 130, which is approximately 60 degrees for the 5-inch-by-5-inch PCB patch antenna.

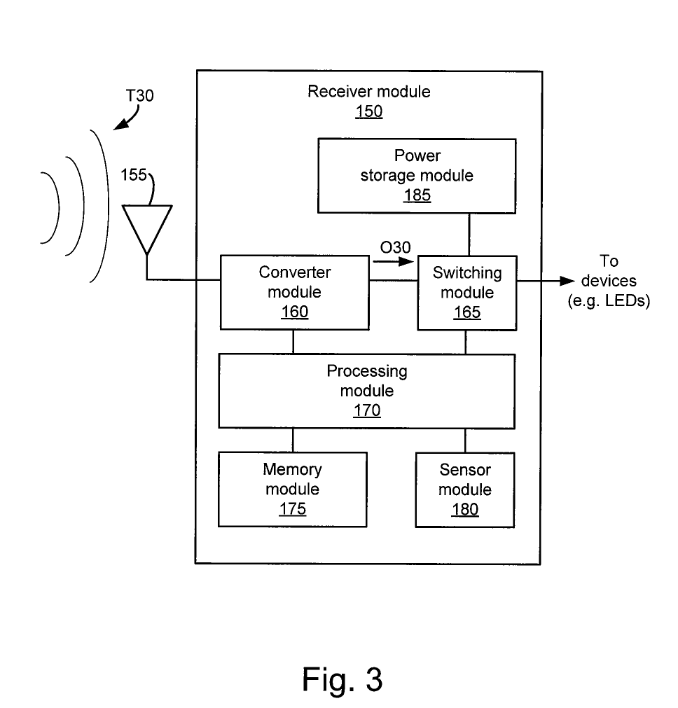

FIG. 3 is a diagram illustrating a receiver module 150, according to an embodiment. The receiver module 150 includes an antenna 155, a converter module 160, a switching module 165, a processing module 170, a memory module 175, a sensor module 180, and a power storage module 185. Each of the components of the receiver module 150 can be software-based (e.g., set of instructions executable at a processor, software code) and/or hardware-based (e.g., circuit system, processor, ASIC, FPGA). The receiver module 150 can include a switch (not shown) to allow a user to turn ON or OFF the receiver module 150. In some embodiments, the receiver module 150 can be turned ON or OFF based on a trigger event such as the expiration of an internal timer or the detection of a predetermined illumination level, for example.

The antenna 155 is configured to receive an input T30 from, for example, a wireless power transmitter. The antenna 155 can be a dipole antenna, for example. The input T30 includes one or more electromagnetic waves having a frequency band in the RF spectrum. The antenna 155 can be optimized to receive electromagnetic waves at or near the center or nominal frequency associated with the input T30. The converter module 160 is configured to convert the power received through the antenna 155 to an output O30 having an associated DC power. The switching module 165 is configured to operate in multiple modes. In one mode, the switching module 165 stores the DC power of the output O30 in the power storage module 185. In another mode, the switching module 165 sends the DC power of the output O30 directly from the converter module 160 to a device to provide DC power to the device. In another mode, the switching module 165 sends the stored DC power in the power storage module 185 to a device to provide DC power to the device.

The processing module 170 is configured to control at least a portion of the operation of the converter module 160, the switching module 165, the memory module 175, the sensor module 180, and/or the power storage module 185. The processing module 170 is configured to receive information associated with the received power, such as AC power and/or DC power (e.g., the output O30) and to determine a parameter to operate a device based on the received power information. For example, the processing module can determine an active time interval (e.g., operating or run time) during which a device can be operated (i.e., provided with DC power by the receiver module) based on the information associated with the received power. In another example, the processing module can determine an inactive time interval (e.g., inactive or disable) during which a device is disabled (i.e., not provided with DC power by the receiver module) based on the information associated with the received power. In this regard, the processing module 170 can receive measurements performed at or before the converter module 160 and/or the power storage module 185, for example. The information associated with the received power can include, for example, an amplitude of an AC power associated with the received power at one or more time instances, an amplitude of the output O30 at one or more time instances, and/or a voltage level associated with the DC power stored in the power storage module 185 at one or more time instances. The processing module 170 is configured to determine a DC power level to be stored in the power storage module 185 to operate the device during a subsequent active period or active time interval. For example, after the receiver module 150 provides power a first time to a device, the processing module 170 can determine a power level (e.g. charge or energy level) to be stored in the power storage module 185 to operate the same device during the device's next period of activity.

The processing module 170 is configured to determine the parameter to operate a device after a trigger or predetermined event is detected. The processing module 170 is configured to receive information about the timing and/or type of trigger event from, for example, a sensor or detector in the receiver module 150. The trigger event can include at least one of a predetermined illumination level threshold (e.g., lighting level in room), a timer expiration (e.g., internal or code-based timer), or a control signal associated with the time interval (e.g., a switch is turned ON). In one embodiment, the receiver module 150 can operate in a first mode before a trigger event is detected and in a second mode after the trigger event is detected. For example, the receiver module 150 can allow DC power to be stored in the power storage module 185 when the receiver module 150 is in the first mode. After the trigger event is detected, the receiver module 150 is in the second mode and the DC power stored in the power storage module 185 is sent to a light-emitting device to operate the device.

The processing module 170 is configured to receive a measurement or indication of a voltage level associated with the DC power stored in the power storage module 185. The processing module 170 is configured to determine the parameter to operate a device based on, for example, the measurement of the voltage level and/or a predetermined power-storage-module voltage level threshold. When, for example, the period of activity of a device is about to end and the DC power stored in the power storage module 185 is running low (e.g., low charge levels), the processing module 170 can control the operation of the switching module 165 such that the DC power associated with output O30 is stored in the power storage module 185 to replenish the power storage module 185 such that there is sufficient stored DC power for a next period of activity of the device. In this instance, the supply of DC power from the receiver module 150 to the device is cut off at the end of the active period and the device becomes disabled (e.g., inactive).

The processing module 170 is configured to modify a duration and/or a start time of the active and/or inactive periods of a device based on, for example, the voltage level associated with the DC power stored in the power storage module 185. For example, when the voltage level is above or below a threshold voltage, the processing module 170 can increase or decrease the duration of the active period, respectively. In this regard, the processing module 170 can adjust the operation of a device such that, for example, a minimum amount of DC power is stored in the power storage module 185. For example, the processing module 170 can adjust the operating time that a light-emitting diode (LED) operates from the power storage module 185 (e.g., a rechargeable battery) such that the total DC power (e.g., charge or energy level) stored in the power storage module 185 does not fall below a predetermined threshold level.

The memory module 175 is configured to store information associated with the DC power, such as an amplitude of the output O30 at multiple time instances and/or a voltage level associated with the DC power stored in the power storage module 185, for example. The memory module 175 can be used by the processing module 170 to store intermediate values and/or finals results associated with operations of the processing module 170, including determining the time interval during which to operate a device.

The sensor module 180 is configured to detect and/or measure a trigger event. The processing module 170 is configured to use information from the sensor module 180 to initiate operations associated with determining a time interval during which to operate a device. For example, the sensor module 180 can include an optical detector (not shown) that is configured to detect an illumination level of the room or the location of the receiver module 150. The sensor module 180 is configured to measure the illumination level and to send a measurement or indication to the processing module 170. The processing module 170 is configured to determine the time interval during which to operate the device when the illumination level measurement is below a predetermined illumination level threshold (e.g., the room is dark).

The power storage module 185 is configured to store DC power or energy produced by the converted module 160. The power storage module 185 can include a rechargeable battery, for example, such that the DC power used by a device from the power storage module 185 can be replenished (e.g., recharge the battery) when the device is not active. In some embodiments, the power storage module 185 can be separate from the receiver module 150. In other embodiments, it is desirable that the receiver module 150 neither includes nor uses a power storage module 185, and instead provides the DC power associated with the output O30 directly to a device for operating the device.

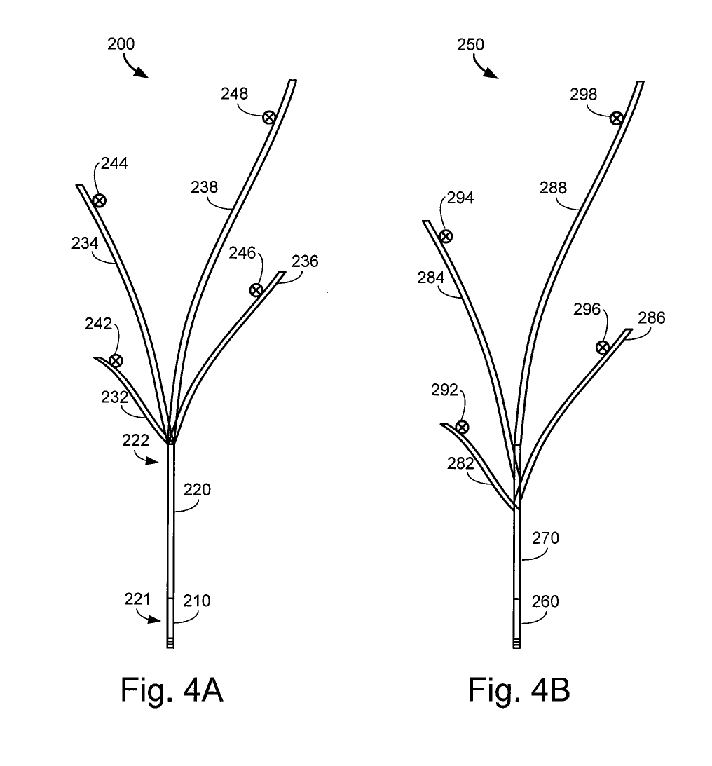

FIGS. 4A and 4B each depicts an illumination device having a trunk, multiple branches, light-emitting devices disposed on the branches, and a receiver module at the base of the trunk, according to an embodiment. FIG. 4A shows an illumination device 200 having a member 220, elongate members 232, 234, 236, and 238, light-emitting devices 242, 244, 246, and 248, and a receiver module 210. The illumination device 200 can be referred to as a light stick or light sticks, for example. The member 220 has a first end portion 221 and a second end portion 222 opposite the first end portion. The member 220 can be referred to as a body or a trunk, for example, of the illumination device 200. The member 220 can be made of a material that is sufficiently strong to support the other components of the illumination device 200. Moreover, the member 220 can be made of a material, such as wood or acrylic, for example, that has limited or no effect on the reception of electromagnetic waves by the receiver module 210. In this regard, the elongate members 232, 234, 236, and 238 can be made of a material having similar electrical and/or mechanical characteristics as those of the member 220.

The receiver module 210 is disposed on the first end portion 221 (e.g., the base) of the member 220. The receiver module 210 can be substantially similar to the receiver modules discussed in connection with FIGS. 1 and 3. In some embodiments, the receiver module 210 can be secured to the first end portion of the member 220 by, for example, a mechanical structure or device (not shown), an adhesive (not shown), a band (not shown), a wrapping tape (not shown), and/or by a strap (not shown). The receiver module 210 can include a dipole antenna to receive the electromagnetic waves.

The elongate members 232, 234, 236, and 238 can be referred to as branches or arms, for example, of the illumination device 200. The elongate members 232, 234, 236, and 238 can be straight, curved, and/or segmented, for example. Each of the elongate members 232, 234, 236, and 238 is configured to be coupled to the second end portion of the member 220. For example, FIG. 4A shows an end portion of each of the elongate members being coupled to the second end portion of the member 220.

Each of the light-emitting devices 242, 244, 246, and 248 is configured to operate based on a DC power produced by the receiver module 210. The light-emitting devices 242, 244, 246, and 248 can be configured in a series configuration or a parallel configuration. The light-emitting devices 242, 244, 246, and 248 can receive the DC power from the receiver module 210 through wires (not shown) coupled (e.g., attached) to the member 220 and/or the elongate members 232, 234, 236, and 238. The light-emitting devices can be, for example, light-emitting diodes. In some embodiments, a light-emitting device can be used as a light source coupled to an optical fiber or like device to provide illumination along a portion of the optical fiber.

FIG. 4B shows an illumination device 250 having a member 270, elongate members 282, 284, 286, and 288, light-emitting devices 292, 294, 296, and 298, and a receiver module 260. The receiver module 260 is disposed on an end portion of the member 270, typically referred to as the base of the trunk or body of the illumination device 250. Different from the embodiment discussed in connection with FIG. 4A, an end portion of each of the elongate members 282, 284, 286, and 288 can be coupled to any point or location along the length of the member 270 including different points or locations along the member 270.

FIG. 4C illustrates an illumination device 300 having elongate members 332, 334, 336, and 338, light-emitting devices 342, 344, 346, and 348, and a receiver module 310. The illumination device 300 need not have a body or trunk. In this regard, the receiver module 310 can be disposed on an end portion of one or more of the elongate members 332, 334, 336, or 338. The elongate members not having the receiver module 310 can be coupled to any point or location along the length of the elongate member having the receiver module 310 or other elongate members.

Each of the receiver modules discussed in connection with FIGS. 4A-4C has a corresponding antenna to receive electromagnetic waves. In one embodiment, the antenna can be a sleeve dipole antenna constructed on, for example, a multilayer PCB. Sleeve dipole antennas allow the receiver module, the antenna, and the wiring from the receiver module to be secured to a trunk or branch of the illumination device in such a manner that the wiring does not interfere with the performance of the antenna. A sleeve dipole antenna can be more desirable than a regular dipole antenna because a sleeve dipole antenna allows the RF power to DC power (RF-to-DC) converter or the receiver module to be close to the feed point location of the antenna without having the wiring from the RF-to-DC converter run next to the antenna and interfere with the antenna performance. Regular dipole antennas, however, use a T-shaped arm such that the wiring from the RF-to-DC converter runs next to the antenna and could interfere with the antenna performance.

In an example, illumination devices 200, 250, and 300 discussed in connection with FIGS. 4A-4C can include elongate members having a length between about 6 inches and about 36 inches. For example, the elongate members can have a length of about 6 inches, 12 inches, 18 inches, 24 inches, or 36 inches. The member or trunk of the illumination devices 200, 250, and 300 can have a length between about 6 inches and about 36 inches. For example, the member can have a length of about 6 inches, 12 inches, 18 inches, 24 inches, or 36 inches. A distance between light-emitting devices in the illumination devices 200, 250, and 300 can be between about 1 inch and about 24 inches. For example, a distance between the light-emitting devices can be about 1 inch, 2 inches, 3 inches, 6 inches, 12 inches, 18 inches, or 24 inches.

While the illumination devices discussed in connection with FIGS. 4A-4C are shown having a certain number of elongate members (e.g., branches or arms) and a certain number of light-emitting devices (e.g., LEDs), other embodiments can include fewer or more elongate members, and/or fewer or more light-emitting devices.

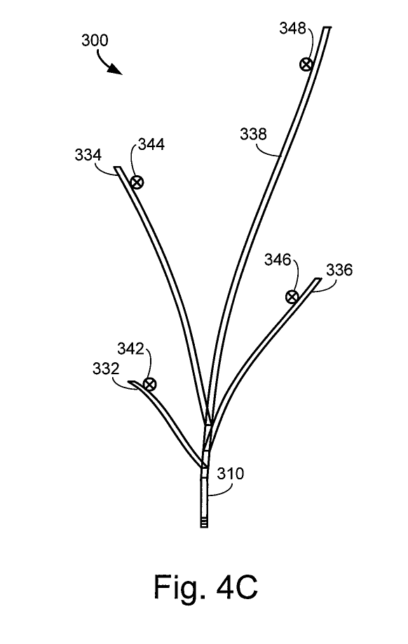

FIGS. 5A and 5B each depicts a converter module configured to output DC power to multiple light-emitting devices for use in, for example, the illumination devices 200, 250, and 300 discussed in connection with FIGS. 4A-4C, according to an embodiment. FIG. 5A shows an antenna 365, a converter module 360, and LEDs 370, 371, 372, and 373. The converter module 360 is configured to convert RF power associated with an electromagnetic wave received via the antenna 365 to an output O51 having an associated DC power (e.g., RF-to-DC conversion). The output O51 can have a DC current associated with the DC power. Because the LEDs 370, 371, 372, and 373 are configured in a series configuration, the DC current of the output O51 is provided to each of the LEDs 370, 371, 372, and 373 for operation.

FIG. 5B shows an antenna 385, a converter module 380, and LEDs 390, 391, 392, and 393. The converter module 380 is configured to convert RF power associated with an electromagnetic wave received via the antenna 385 to an output O52 having an associated DC power. The output O52 can have a DC voltage associated with the DC power. Because the LEDs 390, 391, 392, and 393 are configured in a parallel configuration, the DC voltage of the output O52 is provided to each of the LEDs 390, 391, 392, and 393 for operation.

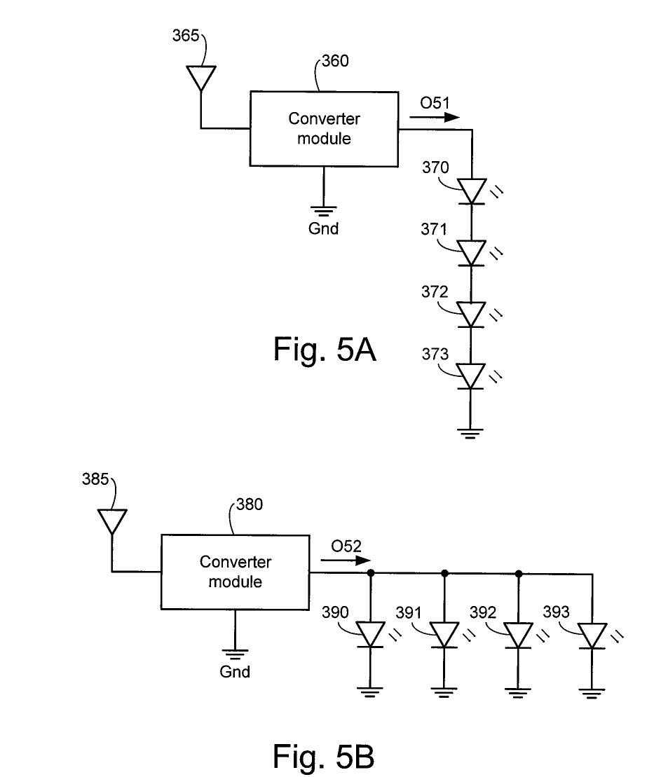

FIGS. 6A and 6B each depicts an illumination device having a receiver module at each branch and at the base of the trunk, according to an embodiment. FIG. 6A shows an illumination device 400 having a member 420, elongate members 432, 434, 436, and 438, light-emitting devices 441, 442, 443, 444, 445, 446, 447, and 448, and receiver modules 410, 412, 414, 416, and 418. The member 420 has a first end portion and a second end portion opposite the first end portion. The member 420 can be referred to as a body or a trunk, for example.

The receiver module 410 is disposed on the first end portion (e.g., the base) of the member 420. The receiver modules 410, 412, 414, 416, and 418 can be substantially similar to the receiver modules discussed in connection with FIGS. 1 and 3. In this regard, each of the receiving modules 410, 412, 414, 416, and 418 has an associated antenna to receive electromagnetic waves. The receiver modules 412, 414, 416, and 418 are disposed on an end portion of the elongate members 432, 434, 436, and 438, respectively, away from the member 420. Each of the receiver modules 410, 412, 414, 416, and 418 can be secured in place by, for example, a mechanical structure or device (not shown), an adhesive (not shown), a band (not shown), a wrapping tape (not shown), and/or by a strap (not shown).

The elongate members 432, 434, 436, and 438 can be referred to as branches or arms, for example, of the illumination device 400. The elongate members 432, 434, 436, and 438 can be straight, curved, and/or segmented, for example. Each of the elongate members 432, 434, 436, and 438 is coupled to the second end portion of the member 220.

Each of the light-emitting devices 441-448 is configured to operate based on a DC power produced by at least one of the receiver modules 410, 412, 414, 416, and 418. The light-emitting devices 441-448 can be configured in a series configuration, a parallel configuration, or a series-parallel configuration. The light-emitting devices 441-448 can receive DC power from the receiver modules 410, 412, 414, 416, and 418 through wires (not shown) coupled (e.g., attached) to the member 420 and/or the elongate members 432, 434, 436, and 438. The light-emitting devices 441-448 can be, for example, light-emitting diodes. In some embodiments, a light-emitting device can be used as a light source coupled to an optical fiber to provide illumination along a portion of the optical fiber.

FIG. 6B shows an illumination device 450 having a member 470, elongate members 482, 484, 486, and 488, light-emitting devices 491, 492, 493, 494, 495, 496, 497, and 498, and receiver modules 460, 462, 464, 466, and 468. The elongate members 282, 284, 286, and 288 are configured to be coupled to any point or location along the length of the member 270.

Because the receiver modules are disposed at the end of each elongate member and at the base of the trunk as discussed in connection with FIGS. 6A and 6B, interference between the antennas associated with the receiver modules is minimized. Moreover, receiver module detuning need not be used as an alternate approach to reduce antenna interference.

In an example, illumination devices 400 and 450 discussed in connection with FIGS. 6A and 6B can include elongate members having a length between about 6 inches and about 36 inches. For example, the elongate members can have a length of about 6 inches, 12 inches, 18 inches, 24 inches, or 36 inches. The member or trunk of the illumination devices 400 and 450 can have a length between about 6 inches and about 36 inches. For example, the member or trunk can have a length of about 6 inches, 12 inches, 18 inches, 24 inches, or 36 inches. A distance between light-emitting devices in the illumination devices 400 and 450 can be between about 1 inch and about 24 inches. For example, a distance between light-emitting devices can be 1 inch, 2 inches, 3 inches, 6 inches, 12 inches, 18 inches, or 24 inches. A distance between receiver modules in the illumination devices 400 and 450 can be between about 6 inches and about 72 inches. For example, the distance between receiver modules can be 6 inches, 12 inches, 18 inches, 24 inches, 36 inches, 42 inches, 48 inches, 54 inches, 60 inches, 66 inches, or 72 inches.

While the illumination devices discussed in connection with FIGS. 6A and 6B are shown having a certain number of elongate members, a certain number of light-emitting devices, and a trunk or body, other embodiments need not have a trunk, can have fewer or more elongate members, and/or can have fewer or more light-emitting devices.

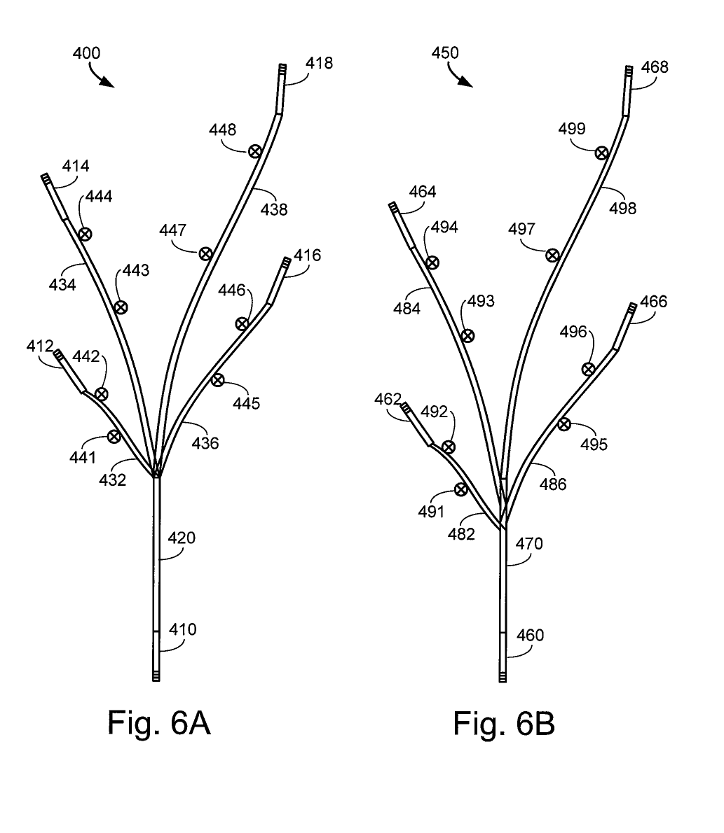

FIG. 7 is a diagram illustrating converter modules 510, 512, 514, and 516 for use with illumination devices 400 and 450 discussed in connection with FIGS. 6A and 6B, according to an embodiment. Each of the converter modules 510, 512, 514, and 516 is configured to output DC power to one or more light-emitting devices. The converter modules 510, 512, 514, and 516 are configured to convert RF power to DC power. In this regard, the converter modules 510, 512, 514, and 516 convert RF power received via antennas 500, 502, 504, and 506, respectively.

The converter module 510 is configured to produce an output O70 having an associated DC power. The converter module 510 can correspond to an RF-to-DC converter used by the receiving module at the base of the trunk in FIGS. 6A and 6B. Similarly, the converter modules 512, 514, and 516 are each configured to produce an output O72, O74, and O76, respectively, where each output has a corresponding DC power. Each of the outputs O70, O72, O74, and O76 can have a DC current and a DC voltage associated with its corresponding DC power.

In this embodiment, the DC voltage of output O70 is added to each of the DC voltages of outputs O72, O74, and O76. The higher operating voltages that result in this embodiment allow a larger number of light-emitting devices to be operated. For example, higher operating voltages allow more LEDs to be operated in series. In this regard, LEDs 520 and 522 are in series configuration and operate based on the output O72, LEDs 524 and 526 are in series configuration and operate based on output O74, and LEDs 528 and 530 are in series configuration and operate based on output O76. In some instances, additional diode (e.g., LED) voltage drops that result from additional LEDs in a series configuration can reduce the overall power conversion efficiency of the illumination device.

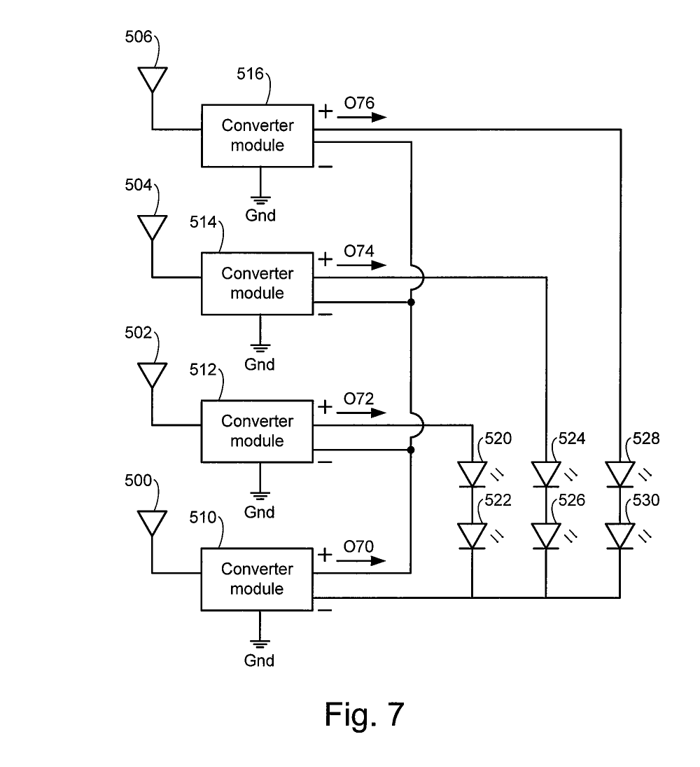

FIG. 8 is a diagram illustrating a transmitter module 600, a container 615 having a receiver module 610, and illumination devices 620 and 625, according to an embodiment. The container 615 can be a vase or a pot, for example. The transmitter module 600 can be substantially similar to the transmitter modules discussed in connection with FIGS. 1 and 2, for example. The transmitter module 600 can include an antenna 605 through which an output T80 is transmitted. The antenna 605 can be a patch antenna, for example. The output T80 can include an electromagnetic wave having a center frequency in a narrow frequency band within the RF spectrum. The receiver module 610 in the container 615 can be substantially similar to the receiver modules discussed in connection with FIGS. 1 and 3, for example. The receiver module 610 can be embedded or integrated with the container 615. In some embodiments, the receiver module 610 is separate from the container 615 and is configured to be coupled to the container 615. The receiver module 610 is configured to receive at least a portion of RF power associated with the output T80. The receiver module 610 is configured to convert the RF power to a DC power. In some embodiments, the receiver module 610 has a power storage module included.

The illumination device 620 includes a member 630 and elongate members 632, 634, 636, and 638, where each elongate member has at least one light-emitting device disposed on the elongate member. The illumination device 625 includes a member 670 and elongate members 682, 684, 686, and 688, where each elongate member has at least one light-emitting device disposed on the elongate member. Each of the light-emitting devices in the illumination devices 620 and 625 is configured to operate based on the DC power produced by the receiver module 610. In some embodiments, a driver (not shown) can be used to adjust and/or control a DC current and/or a DC voltage associated with the DC power produced by the receiver module 610.

While the container 615 in FIG. 8 is shown having two illumination devices, other embodiments can include fewer or more illumination devices. In this regard, the effective operation of more than one illumination device with the container 615 can be based on the total power available at the receiver module 610 from the transmitter 600.

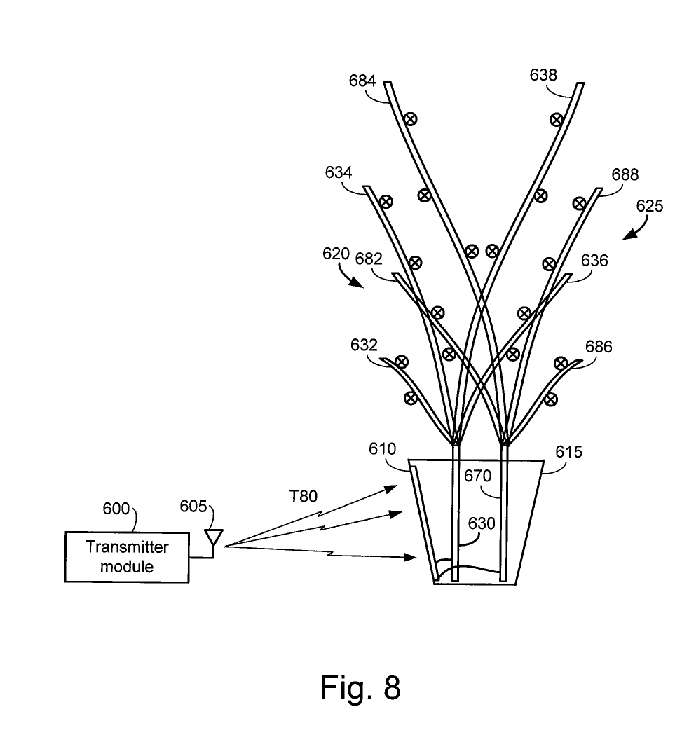

FIG. 9 is a diagram illustrating an illumination device 700 having unlit elongate members, according to an embodiment. The illumination device 700 includes a member 720, elongate members 732, 734, 736, 738, and 739, multiple light-emitting devices, such as light-emitting devices 742, 746, 748, and 749, receiver modules 710, 712, 714, and 716, and unlit (e.g., without light-emitting devices) elongate members 730, 735, 737, and 740. The member 720 can be referred to as a body or a trunk, for example, of the illumination device 700. In some embodiments, the illumination device 700 need not include a trunk.

The receiver modules 710, 712, 714, and 716 are disposed on the unlit elongate members 730, 735, 737, and 740, respectively. The receiver modules 710, 712, 714, and 716 can be substantially similar to the receiver modules discussed in connection with FIGS. 1 and 3. In this regard, each of the receiving modules 710, 712, 714, and 716 has an associated antenna to receive electromagnetic waves. The unlit elongate members 730, 735, 737, and 740 can be referred to as unlit branches or unlit arms, for example, of the illumination device 700. The unlit elongate members can typically be shorter than the elongate members because the unlit elongate members do not have light-emitting devices. The unlit elongate member 730, 735, 737, and 740 can be coupled to an elongate member and/or to an end portion of the member 720.

The elongate members 732, 734, 736, 738, and 739 can be referred to as branches or arms, for example, of the illumination device 700. The elongate members 732, 734, 736, 738, and 739 can be straight, curved, and/or segmented, for example. An end portion of each of the elongate members 732, 734, 736, 738, and 739 is coupled to an end portion of the member 720.

Each of the light-emitting devices is configured to operate based on a DC power produced by at least one of the receiver modules 710, 712, 714, and 716. In this regard, the outputs from the receiver modules 710, 712, 714, and 716 can be configured into a power bus. The light-emitting devices can receive DC power from the power bus through wires (not shown) disposed (e.g., attached) on the member 720, the elongate members 732, 734, 736, 738, and 739, and/or the unlit elongate members 730, 735, 737, and 740. It may be desirable to have the receiver modules disposed on the unlit elongate members to reduce or minimize interference with the power bus wiring.

The light-emitting devices shown in FIG. 9 can be configured in a series configuration, a parallel configuration, or a series-parallel configuration. The light-emitting devices can be, for example, light-emitting diodes. In some embodiments, a light-emitting device can be used as a light source coupled to an optical fiber to provide illumination along a portion of the optical fiber.

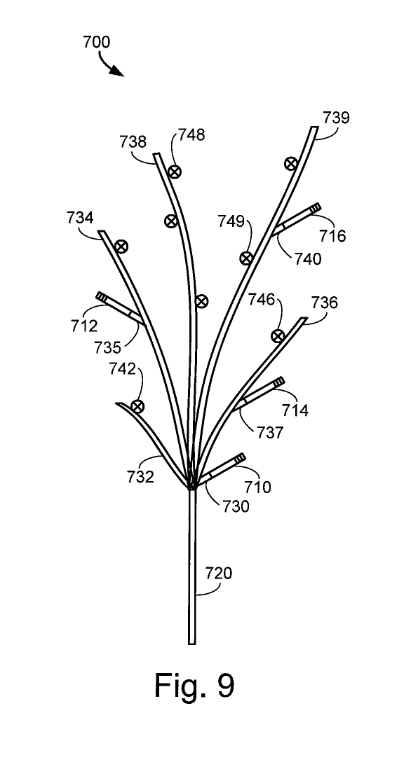

FIG. 10 is a block diagram illustrating converter modules 810, 812, and 814 for use with illumination device 700 in FIG. 9, according to an embodiment. The converter modules 810, 812, and 814 are configured to convert RF power to DC power. In this regard, the converter modules 810, 812, and 814 convert RF power received via antennas 800, 802, and 804, respectively. The converter module 810 is configured to produce an output O100 having an associated DC power. Similarly, the converter modules 812 and 814 are configured to produce outputs O102 and O104, respectively, where each output has a corresponding DC power. Each of the outputs O100, O102, and O104 has a DC current and DC voltage associated with its corresponding DC power.

In the embodiment discussed in connection with FIG. 10, the outputs O100, O102, and O104 are combined into a power bus having a positive portion 830 (+ Bus) and a negative portion 840 (− Bus). The power bus is an input to a driver 850. The driver 850 is configured to adjust a DC current and/or a DC voltage associated with the power bus to operate the light-emitting devices 820, 821, 822, 823, 824, 825, 826, 827, and 828. For example, the driver 850 can adjust a DC current and/or a DC voltage supplied to the light-emitting devices to produce substantially the same illumination (e.g. lighting) level by each of the light-emitting devices. The driver 850 can be used to increase or boost the DC voltage of the power bus to operate multiple light-emitting devices. In some instances, using a driver can reduce the overall power efficiency conversion of the illumination device.

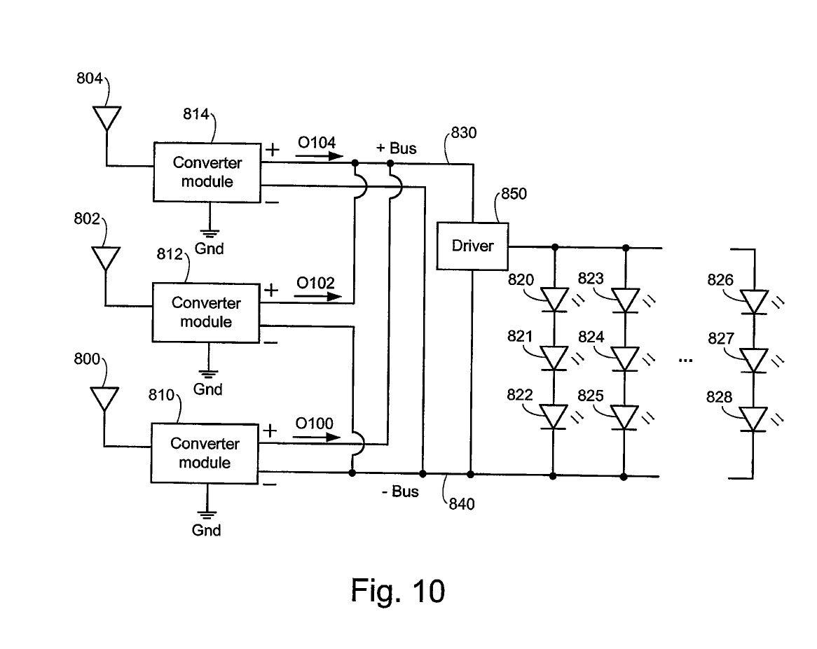

FIG. 11 is a diagram illustrating an illumination device 900 having a receiver module for each light-emitting device. The illumination device 900 includes a member 920, elongate members 932, 934, 935, 936, 938, and 939, light-emitting devices 942, 944, 945, 946, 948, and 949, and receiver modules 912, 914, 916, 918, and 919. The member 920 can be referred to as a body or a trunk, for example. In some embodiments, the illumination device 900 need not include a trunk.

The receiver modules 912, 914, 916, 918, and 919 are disposed on the elongate members 932, 934, 935, 936, 938, and 939, respectively. The receiver modules 912, 914, 916, 918, and 919 can be substantially similar to the receiver modules discussed in connection with FIGS. 1 and 3. Each of the receiver modules 912, 914, 916, 918, and 919 can be secured to its corresponding elongate member.

The elongate members can be referred to as branches or arms, for example, of the illumination device 900. The elongate members 932, 934, 935, 936, 938, and 939 can be straight, curved, and/or segmented, for example. An end portion of each of the elongate members 932, 934, 936, and 938 is coupled to an end portion of the member 920. As shown in FIG. 11, an end portion of the elongate member 935 is coupled to the elongate member 934 and an end portion of the elongate member 939 is coupled to the elongate member 938. In this regard, the elongate members 935 and 939 can be referred to as a sub-branches or sub-arms of the illumination device 900.

Each of the light-emitting devices in the illumination device 900 is configured to operate based on a DC power produced by a corresponding receiver module. For example, the light-emitting device 942 is configured to be powered by the receiver module 912. Similarly, the light-emitting device 948 is configured to be powered by the receiver module 918.

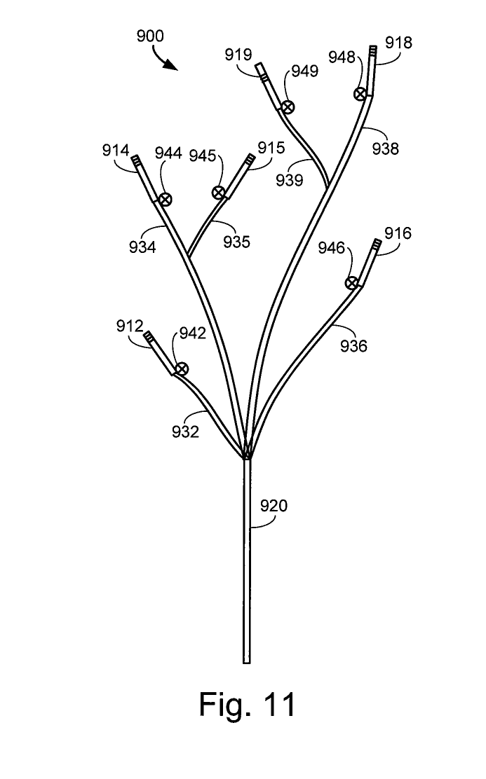

FIG. 12 is a block diagram illustrating converter modules 1010, 1012, and 1014 for use with illumination device 900 in FIG. 11, according to an embodiment. Each of the converter modules 1010, 1012, and 1014 is configured to convert RF power to DC power. In this regard, the converter modules 1010, 1012, and 1014 convert RF power received via antennas 1000, 1002, and 1004, respectively. Each of the converter modules 1010, 1012, and 1014 is configured to output a DC power to a single light-emitting device. The converter module 1010 is configured to produce an output O120 having an associated DC power that is used to power the LED 1020. The converter module 1012 is configured to produce an output O122 having an associated DC power that is used to power the LED 1022. The converter module 1014 is configured to produce an output O124 having an associated DC power that is used to power the LED 1024. Because each converter module drives a single LED, a driver and/or a power storage device (e.g., a battery) need not be used. Moreover, sufficient separation between converter modules is desirable to minimize the effect of antenna interference in the overall system performance.

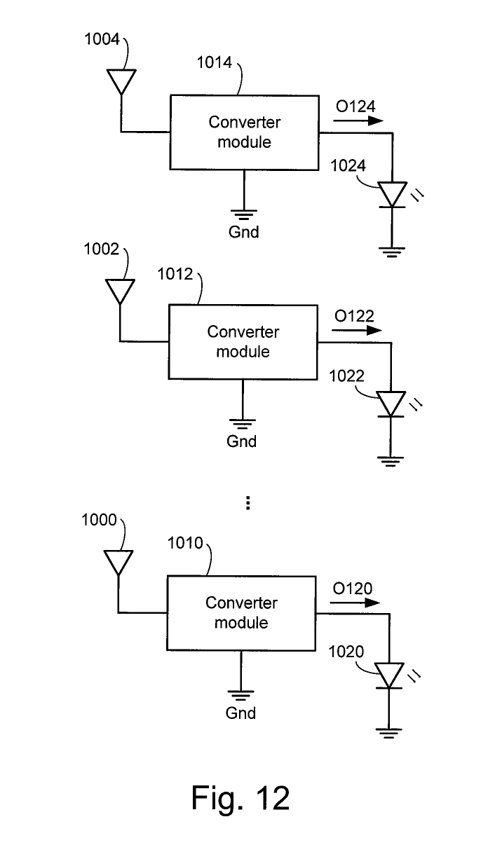

FIG. 13 is a diagram illustrating expanded views A, B, and C of an illumination device 1100 respectively showing a light-emitting device attached to a branch and showing a receiver module attached to a base of a trunk, according to an embodiment. Expanded view A shows an embodiment having a light-emitting device 1140 coupled (e.g., attached) to a portion of an elongate member 1130. A wire 1150 is coupled to the light-emitting device 1140 to provide DC power to the light-emitting device 1140, and the wire 1150 is secured to the elongate member 1130 in some manner (not shown). Expanded view B shows another embodiment having a light-emitting device 1142 coupled to a portion of an elongate member 1132. A wire 1152 is coupled to the light-emitting device 1142 to provide DC power to the light-emitting device 1142 and the wire 1152 is secured to the elongate member 1132 by a band, strap, or wrapping tape 1160.

Expanded view C in FIG. 13 shows a receiver module 1110 having an antenna 1112 and an electronic system 1114. The receiver module 1110 can be disposed on an end portion of the member 116 (e.g., trunk), such as the base of the member 116. The electronic system 1114 can include an RF-to-DC converter and/or other components as disclosed for the receiver modules in FIGS. 1 and 3. The electronic system 1114 can include one or more integrated circuits and/or electronic components (e.g., capacitors, inductors, resistors) on a PCB. A wire 1154 is coupled to the receiver module 1110 and is configured to provide a DC power output from the receiver module 1110 to the light-emitting devices in the illumination device 1100.

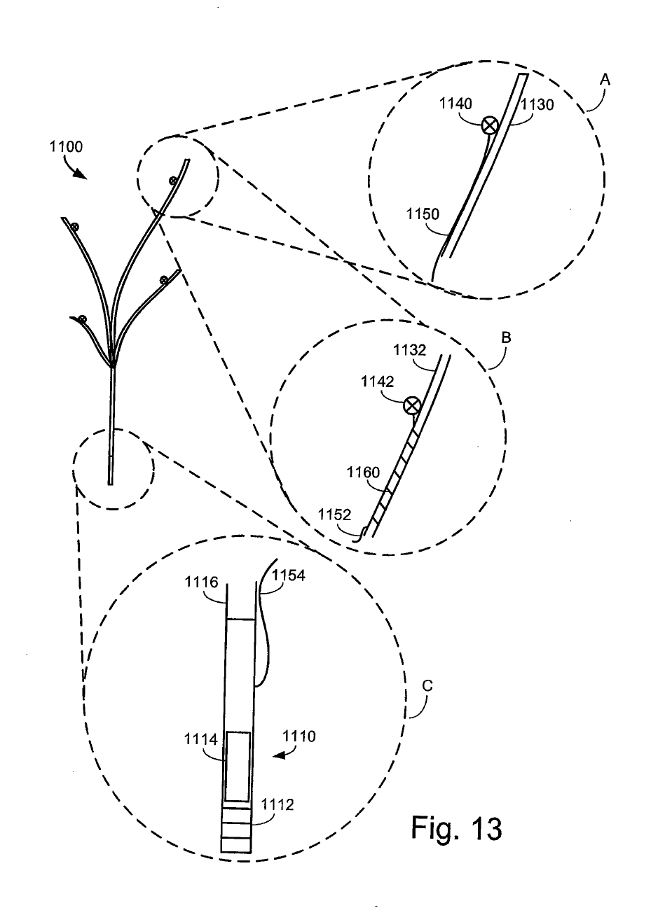

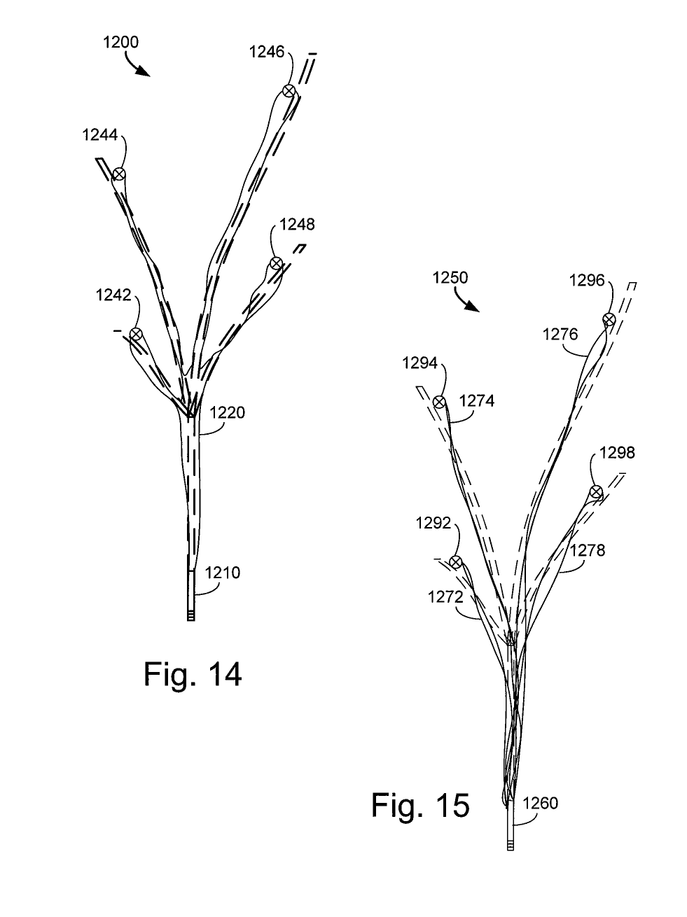

FIGS. 14 and 15 each depicts an illumination device having multiple light-emitting devices wired to a receiver module, according to an embodiment. FIG. 14 shows an illumination device 1200 (partially shown in phantom) having a receiver module 1210, light-emitting devices 1242, 1244, 1246, and 1248, and wiring 1220. The light-emitting devices 1242, 1244, 1246, and 1248 are configured in a series configuration and are wired to each other and to the receiver module 1210 via the wiring 1220. FIG. 15 shows an illumination device 1250 (partially shown in phantom) having a receiver module 1260, light-emitting devices 1292, 1294, 1296, and 1298, and wiring 1272, 1274, 1276, and 1278. Each of the light-emitting devices 1292, 1294, 1296, and 1298 is wired to the receiver module 1260 in a parallel configuration. In this regard, the light-emitting devices 1292, 1294, 1296, and 1298 are wired to the receiver module 1260 via the wiring 1272, 1274, 1276, and 1278, respectively.

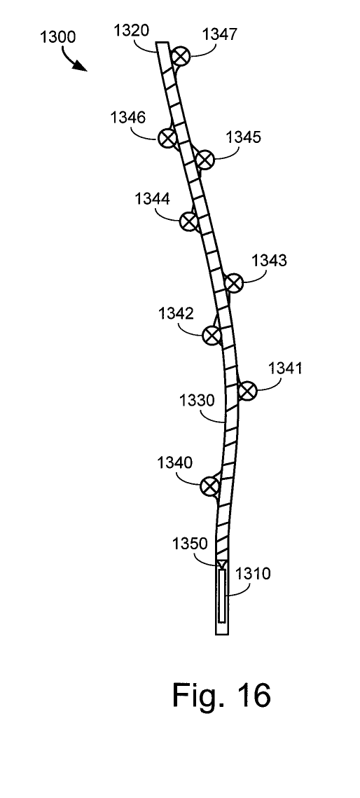

FIG. 16 is a diagram illustrating an illumination device 1300 having a single elongate member 1320 and a receiver module 1310 coupled to the base of the elongate member 1320, according to an embodiment. The illumination device 1300 includes a receiver module 1310 and light-emitting devices 1340, 1341, 1342, 1343, 1344, 1345, 1346, and 1347. The receiver module 1310 is configured to provide DC power to the light-emitting devices via a wire 1350. The light-emitting devices can be configured in a series configuration or a parallel configuration. In an embodiment, the light-emitting devices 1340-1347, the receiver module 1310, and/or the wire 1350 are secured to the elongate member 1320 by a wrapping tape 1330. The wrapping tape 1330 can include an adhesive side, for example, to secure the components of the illumination device 1300 to the elongate member 1320. Other forms of securing the components of the illumination device 1300 to the elongate member 1320 can be used.

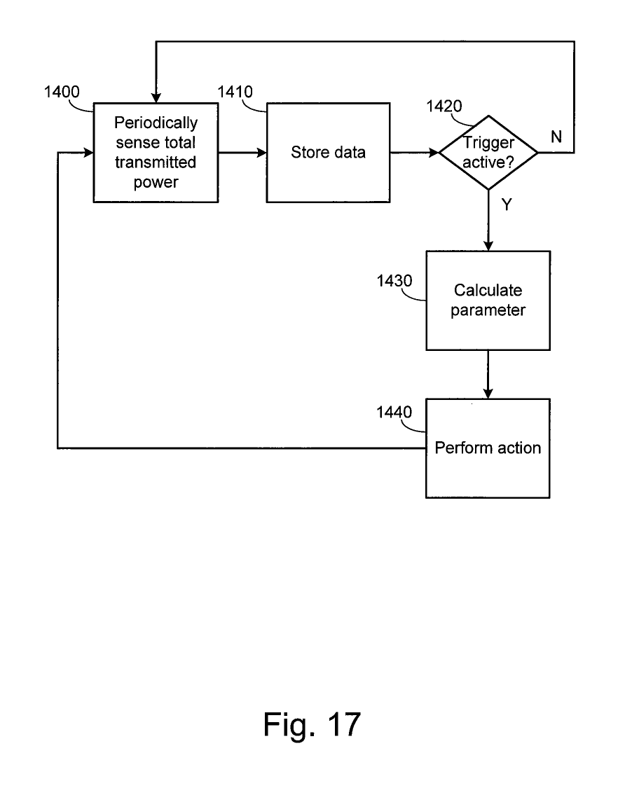

FIG. 17 is a flow chart illustrating a method according to an embodiment. In step 1400, a receiver module, such as the receiver modules described in FIGS. 1 and 3, for example, can sense, detect, or measure an amplitude or amount of wirelessly-received power. The receiver module can measure the wirelessly-received power at multiple time instances such as multiple predetermined time instances. The receiver module can measure, for example, a DC power after an RF-to-DC conversion of wirelessly-received power occurs. The DC power measurement can be based on, for example, a DC voltage and/or a DC current associated with the DC power. In some instances, the receiver module can measure a DC power stored in a power storage module (e.g., a rechargeable battery).

In step 1410, the receiver module can store the information associated with the measurements of the DC power in a memory module such as the memory module discussed in connection with FIG. 3, for example. In one example, the information associated with the DC power can include an indicator of an amplitude of DC power output by an RF-to-DC converter in the receiver module at multiple predetermined time instances or an indicator of a voltage level associated with the DC power stored in a power storage module.

In step 1420, the receiver module can determine whether a trigger event has occurred. When a trigger event has not occurred (e.g. a trigger is not activated), the receiver module can return to step 1400. When a trigger event has occurred, the receiver module can proceed to step 1430. A signal can be generated within the receiver module to indicate that a trigger event has occurred when, for example, a light sensor detects a room illumination level below a certain threshold level or a processing module detects an expired background timer. In step 1430, the receiver module can determine or calculate a parameter value in response to the trigger event. In determining a value for a parameter, the receiver module can use the temporal and/or quantitative information associated with the DC power stored in step 1410. For example, for devices having an active period and an inactive period, the receiver module can determine a duration of time for the active period and a duration of time for the inactive period (e.g., a duty cycle) that is based on how much DC power is stored and/or how much DC power can be expected to be received in the future. In another example, the receiver module can determine different sampling times for measuring levels of DC power in a rechargeable battery. For example, the receiver module can reduce the time duration between sample times such that the DC power level does not fall below a threshold level before a next sample time.

In step 1440, the receiver module can perform an activity or generate signals to control the operation of component(s) of a device such as an illumination device, for example. The receiver module can operate an LED for a time interval determined based on the information associated with the DC power. In some embodiments, the receiver module can include a temperature sensor and can control the operation of the temperature sensor to make temperature measurements. Temperature measurements could be desirable to operate the receiver module in safe conditions. In some embodiments, the temperature readings by a temperature sensor can be very fast, about 40 milliseconds, for example. As described above, the receiver module can adjust the time interval during which a device (e.g., an LED) is to be active (i.e., in operation) or inactive (i.e., inoperative or disabled) based on the information associated with the DC power. In some instances, the device can have more than two modes of operation, for example, an active HIGH mode (e.g., high level of illumination), an active LOW (e.g., low level of illumination), and an OFF. When the device is inactive, the receiver module can store DC power for a next instance of activity by the device. By properly calculating the periods of activity (e.g., discharging) and inactivity (e.g. recharging), the receiver module can more effectively operate the device by dynamically managing the level of DC power stored. After step 1140, the method can proceed to step 1400.

The receiver module discussed with respect to FIG. 17 can be configured to adjust the operation of the system (e.g., illumination device) based on, for example, the total amount of power received from a transmitter module. Communication (e.g., information transferred) between the receiver module and the transmitter module is not required. The transmitter module can be configured to transmit a certain amount of power wirelessly to the receiver module without having consideration for the current status or operation of the receiver module. The receiver module can be configured to use rechargeable batteries and operate in a manner that automatically recharges the batteries, thus reducing the likelihood that a device, such as an LED, does not operate because the DC power level in the rechargeable battery is below a threshold level.

The receiver module discussed with respect to FIG. 17 includes a processing module (e.g., a microcontroller, central processing unit) such as the processing module 170 discussed in connection with FIG. 3. The processing module can be configured to monitor the received power over time. Based on the temporal and quantitative information associated with the power received by the receiver module, the processing module can, for example, adjust the duty cycle (e.g., duration of active and inactive periods) of the device to be operated to ensure that the device has sufficient power. The processing module is configured to use the amount of charge (e.g., DC power) from a power storage module that the processing module has determined can be replenished during the period of inactivity of the device (e.g., when the device is disabled or OFF). In this manner, the processing module can ensure that the charge level in the power storage module does not fall below a certain threshold level. For example, for LED-based light sticks, the processing module monitors the power received from the transmitter module and adjusts the LED run-time based on how much power is being stored in the power storage module. For example, when the receiver module is at about 2 feet from the transmitter module, the LED operating time interval is approximately 8 hours and the period of inactivity (e.g., recharging) is 16 hours. At a distance of 4 feet, however, the received power is approximately ¼ of that received by the receiver module at 2 feet. The processing module adjusts the active time interval accordingly to approximately 2 hours and the period of inactivity to 22 hours. In this example, the duty cycle for the operation of the LED changed, however, the period remained a 24-hour period.

In another embodiment, it is desirable that a voltage level of a power storage element used with the receiver module discussed with respect to FIG. 17 does not drop below a certain (e.g., predetermined) level. By maintaining the DC power stored in a power storage module above a certain level, the life of the power storage module can be extended. For example, rechargeable alkaline batteries can be recharged after being completely discharged about 50 times. When the rechargeable alkaline batteries are partially discharged, the number of recharges can be higher than 500 times, for example. In some embodiments, where a single recharge is needed in a day, avoiding the DC power (e.g., charge) in the power storage module from being completely discharged can extend the operation of the power storage module from 50 days to 500 or more days.

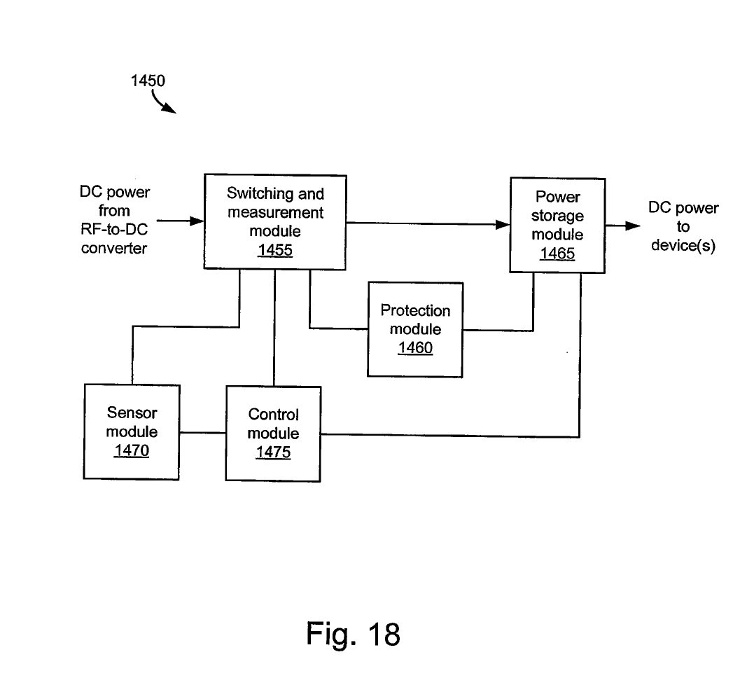

FIG. 18 is a block diagram of a receiver module 1450 having a switching and measurement module 1455, a protection module 1460, a power storage module 1465, a sensor module 1470, and a control module 1475, according to an embodiment. One or more of the components of the receiver module 1450 can be software-based (e.g., set of instructions executable at a processor, software code) and/or hardware-based (e.g., circuit system, processor, ASIC, FPGA). The switching and measurement module 1455 is configured to receive DC power from, for example, an RF-to-DC converter (not shown). The switching and measurement module 1455 can be configured to operate in one or more modes. For example, during a measurement mode, the switching and measurement module 1455 can measure, detect, or sense a voltage or a current associated with the DC power. In another example, during a charging mode, the switching and measurement module 1455 can send DC power to the power storage module 1465 for storage. In another example, during a protection mode, the switching and measurement module 1455 can disconnect the power storage module 1465 from the DC power. In some instances, more than one mode can occur at the same time, for example, the measurement mode and the charging mode can be active at the same time. The modes or states of the switching and measurement module 1455 can controlled based on one or more signals from, for example, the sensor module 1470 and/or the control module 1475.

The sensor module 1470 is configured to produce and/or detect an event that can trigger an active operation of a device (not shown) from the DC power stored in the power storage module 1465. The sensor module 1470 can be configured to provide the control module 1475 with a signal or an indicator of the trigger event. These signals can include, but need not be limited to, analog signals, digital signals, and/or modulated signals, for example.

The control module 1475 is configured to control at least a portion of the switching and measurement module 1455 and/or the power storage module 1465. In this regard, the control module 1475 can be configured to control (e.g., determine and/or adjust) a parameter to operate a device (e.g., run time, inactivity period) based on, for example, a signal from the sensor module 1470 and/or a measurement received from the switching and measurement module 1455. In some embodiments, the control module 1475 can include an analog circuit in which the active period and/or inactive period of the device is determined based on temporal behavior of certain components (e.g., discharge time of a capacitor). In other embodiments, the control module 1475 is an application specific circuit (e.g., custom-designed circuit) or a general-purpose circuit (e.g., a microcontroller), for example.

The protection module 1460 is configured to disconnect the power storage module 1465 from DC power by, for example, allowing the switching and measurement module 1455 to enter the protection mode. The protection mode is activated when, for example, the DC voltage level at the power storage module 1465 is above a safe voltage level. In another example, the protection mode is activated when the DC current level to the power storage module 1465 is above a safe charging current level.

The power storage module 1465 is configured to store DC power (e.g., charge or energy) from the RF-to-DC converter. In this regard, the power storage module 1465 can store DC power during a period of inactivity of a device and can send DC power to the device during a period of activity of the device. In some embodiments, the charging of the power storage module 1465 need not be a separate mode, state, or operation from the discharging of the power storage module that occurs when providing or sending DC power to a device. For example, when more DC power is available than can be used by the device, the remaining or unused DC power can be stored in the power storage module 1465.

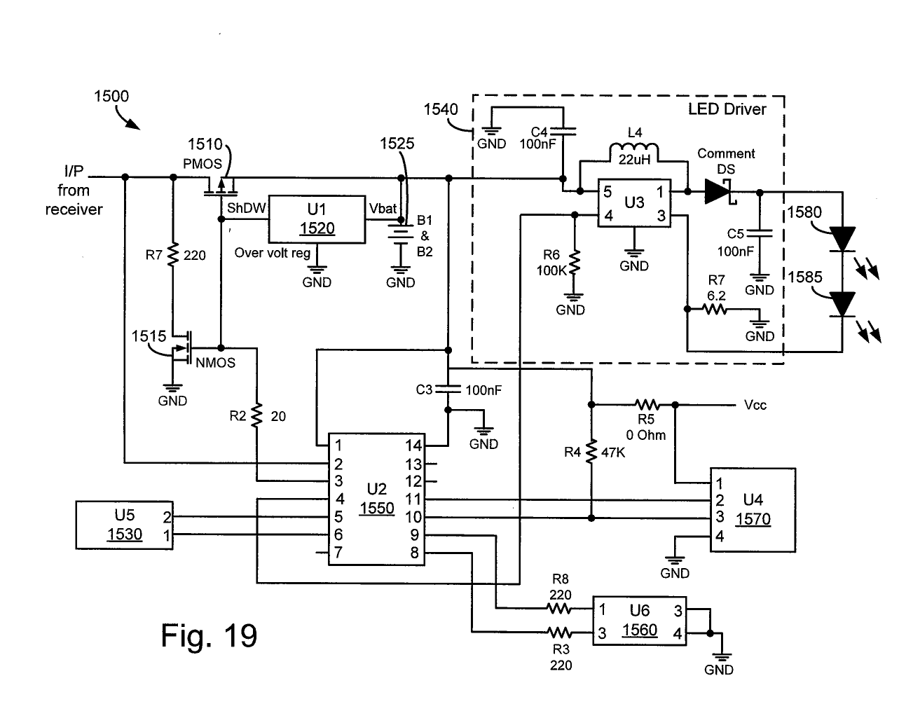

FIG. 19 is a schematic diagram of a specific example of a receiver module as discussed in connection with FIG. 18, according to an embodiment. FIG. 19 shows a receiver module 1500 that includes a p-type metal-oxide-semiconductor (PMOS) transistor 1510, an n-type metal-oxide-semiconductor (NMOS) transistor 1515, an over-voltage regulator 1520, rechargeable battery or batteries 1525, a first connector 1530, a processor 1550, an LED driver 1540, a status indicator 1560, a second connector 1570, and LEDs 1580 and 1585.

The LED driver 1540 includes an integrated circuit (e.g., a chip) (labeled U3) that uses several external parts or components (shown within a shaded box) for its operation. In the example shown in FIG. 18, the LED driver 1540 is an LTI937ES5 driver. The LED driver 1540 is configured to receive DC power from the rechargeable battery 1525 and to convert a DC voltage associated with the DC power into a predetermined or preset DC current. The rechargeable battery 1525 can be a rechargeable alkaline battery, for example. The DC current value is determined, at least partially, by a current sense resistor (e.g., resistor R7). In the example shown in FIG. 19, the predetermined DC current from the LED driver 1540 is approximately 15 milliamps (mA). The number of LEDs coupled to an output of the LED driver 1540 may vary depending on the application. In this example, two LEDs are operated in series based on the predetermined DC current output from the LED driver 1540.

The processor 1550 can typically be a processor configured to operate at low power. For example, the processor 1550 can use less than 1 microamp (μA) during a sleep mode. In the example shown in FIG. 19, the processor 1550 is an ultra-low power microcontroller MSP430F2012 from Texas Instruments. The processor 1550 can include an analog-to-digital converter (ADC) that is used to convert analog measurements associated with the DC power in the receiver module 1550 to a digital value for processing and/or storage. For example, the ADC can convert information associated with received power or a DC power level in the rechargeable battery 1525. In this regard, the DC power level in the rechargeable battery 1525 can be determined based on a voltage reference internal to the processor 1550.

The processor 1550 is configured to enable or disable the LED driver 1540. The processor 1550 can control the LED driver 1540 to conserve power or to produce a desirable lighting effect such as dimming, for example. LEDs produce more illumination (e.g., more lumens) when driven at the proper current level. If the current level is too low, the LEDs produce less light. In the example shown in FIG. 19, the processor 1550 is configured to control the LED driver 1540 such that the LEDs 1580 and 1585 operate at 60 Hertz (Hz) with a duty cycle having an active duration of approximately 13.3% of the 60 Hz period. The resulting output current from the LED driver 1540 is approximately 15 mA at 13.3% duty cycle such that the average output current from the LED driver 1540 is 2 mA.

The processor 1550 is configured to receive a measurement of the power received by the receiver module 1500. In this example, pulling HIGH (e.g., to Vcc) Pin 3 of the processor 1550 configures the processor 1550 to process a measurement of the received power. In this configuration, the NMOS transistor 1515 is turned ON and the PMOS transistor 1510 is turned OFF. The received DC power produces a voltage across resistor R7 that is proportional to the DC power level received. The processor 1550 uses the embedded ADC, which is connected to Pin 2, to obtain a measurement of the voltage across resistor R7 and to determine the DC power level received. As described above, the calculation of the DC power received by the receiver module 1500 is used to determine a value for the battery 1525 recharging current. The rechargeable battery 1525 recharging current value is used to determine the amount of charge (e.g., DC power) stored in the rechargeable battery 1525 and available to, for example, operate the LEDs 1580 and 1585. After determining the recharging current value, the processor 1550 is configured to bring LOW (e.g., to ground) Pin 3 such that the received DC power is stored in the rechargeable battery 1525. In this configuration, the NMOS transistor 1515 is turned OFF and the PMOS transistor 1510 is turned ON. It should be noted that this approach can momentarily disconnect the rechargeable battery 1525 from a corresponding RF-to-DC converter. In another embodiment, the receiver module 1500 can be configured to sense or measure the recharging current without having to disconnect the rechargeable battery 1525 from the RF-to-DC converter.

The voltage regulator 1520 is configured to ensure that the rechargeable battery 1525 is not overcharged or damaged. The voltage regulator 1520 can be an integrated circuit, for example, configured to protect the rechargeable battery 1525 from an over-voltage condition. In the example shown in FIG. 19, the over-voltage regulator 1520 is a MAX809JTR from ON Semiconductor. When an over-voltage condition is detected by the voltage regulator 1520, the ShDw Pin is set HIGH by the over-voltage regulator 1520 such that the NMOS transistor 1515 is turned ON and the PMOS transistor 1510 is turned OFF. This configuration disconnects the rechargeable battery 1525 from the received DC power such that no further charging occurs. When the over-voltage condition is over, the ShDw pin is set LOW by the voltage regulator 1520 and the rechargeable battery 1525 is reconnected to the received DC power for further charging.

Other components shown in FIG. 19 include resistor R2 that is configured as an isolation resistor used to ensure that the processor 1550 and the voltage regulator 1520 do not damage one another if both attempted to control the operation of the PMOS transistor 1510 and the NMOS transistor 1515. The first connector 1530 is configured to receive a signal corresponding to a trigger event and to provide the signal to the processor 1550. The second connector 1570 is configured to allow programmability of the processor 1550. The status indicator 1560 is a light indicator (e.g., LED indicator) configured to provide visual indication of certain status or operation of the receiver module 1500. In the example shown in FIG. 19, the NMOS transistor 1515 is a NTA4153N from ON Semiconductor, the PMOS transistor 1510 is a NTA4151P from ON Semiconductor, the first connector 1530 is a 100 mil connector, the second connector is a BU127L4MPE, and the status indicator 1560 is an HSMF-C155 surface-mount-chip LEDs from Agilent.

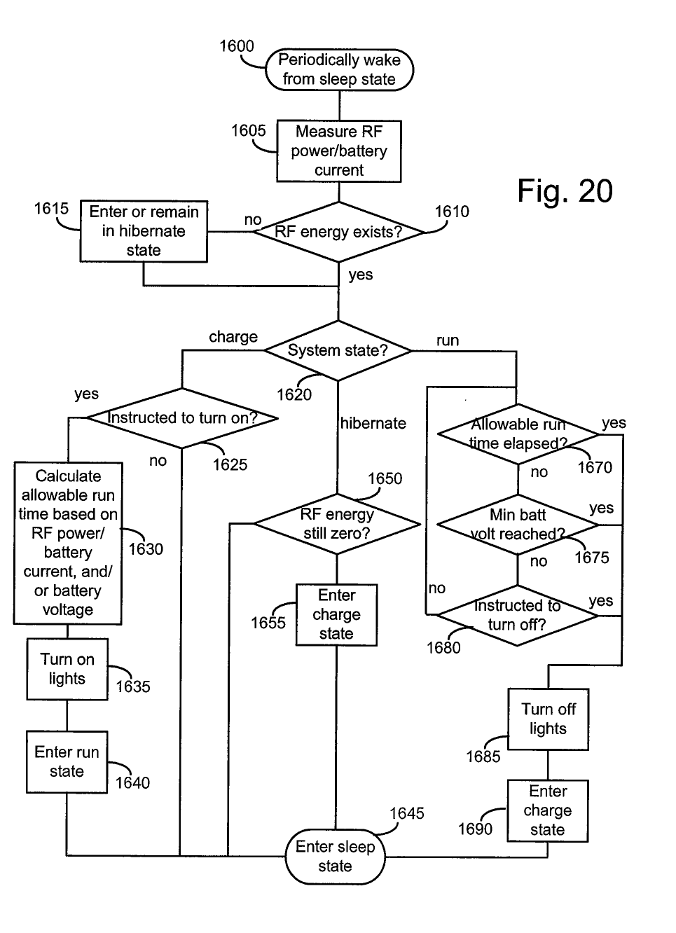

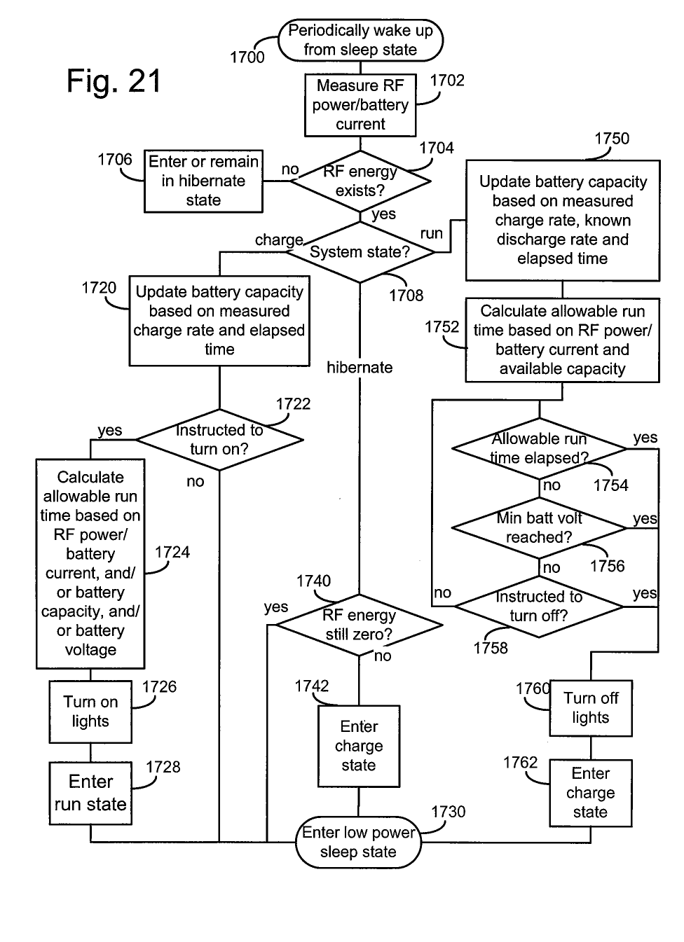

FIGS. 20-21 are flow charts each illustrating a method for operating an illumination device, according to an embodiment. FIG. 20 is a flow chart of the operation of a receiver module in an illumination device having a constant distance to a transmitter module and in which the capacity of a power storage module need not be determined. In step 1600, the receiver module in the illumination device is periodically awaken from a low power SLEEP state, at which point the illumination device's operation is initiated. The illumination device's operation is based on multiple states. For example, in a RUN state, the light-emitting devices are illuminated. In a CHARGE state, the light-emitting devices are not illuminated and the power storage module is being charged. In a HIBERNATE state, no RF power to charge the power storage module is available and the illumination device operates such that a negligible amount of power is consumed to reduce draining the stored DC power in the power storage module. The time duration of each of the states, SLEEP, RUN, CHARGE, and HIBERNATE need not be the same. When the illumination device is turned ON (e.g., awakened) for the first time, the HIBERNATE state is a default initial state. It should be noted that the illumination device's states have been described in terms of lighting conditions. For other devices that use a receiver module but are not illumination devices, the various states can be described in terms of other conditions.

In step 1605, the RF power available to the receiver module is measured. In this regard, the RF power need not be measured directly but can be determined based on the amount of DC power or charge current produced by the RF-to-DC conversion operation. When no RF power (i.e., no DC power or charge current) is available, it may be desirable to minimize the amount of charge that is used (e.g., drained) from the power storage module. In step 1610, when there is insufficient or no RF power available at the receiver module, the process proceeds to step 1615 and the receiver module enters a HIBERNATE state or remains in a HIBERNATE state if it is the current active state. When sufficient RF power is available at the receiver module, the process proceeds to step 1620. In step 1620, the receiver module determines the next state of operation based on the measured amount of RF power available. When the next state of operation is CHARGE, the process proceeds to step 1625. When the next state of operation is HIBERNATE, the process proceeds to step 1650. When the next state of operation is RUN, the process proceeds to step 1670 and implemented beginning at step 1670.

In step 1625, while the power storage module is being charged (e.g., DC power is being stored), a trigger event to turn ON the receiver module is monitored. A trigger event can include at least one of an infrared (IR) signal, an audio signal, or a toggling ON/OFF the RF power in a known or detectable manner. When a trigger event to turn ON the receiver module is not detected, the receiver module remains in step 1625. When a trigger event to turn ON the receiver module is detected, the process proceeds to step 1630.

In step 1630, the receiver module determines a run time or time interval to operate the illumination device (e.g., turn ON the light-emitting devices). In this regard, the distance between the receiver module and the transmitter module is constant such that a predetermined run time or time interval to operate the illumination device can be used. In some instances, the run time can be reduced based on, for example, an inadequate charging time or the power-storage-module voltage indicates that the available capacity of the power storage module is not sufficient to operate the illumination device for the entire run time. In step 1635, after the run time or time interval is determined and/or adjusted, the receiver module allows for the light-emitting devices in the illumination device to turn ON. In step 1640, the receiver module enters the RUN state as described in step 1620.

Returning to step 1620, when the next state of operation is HIBERNATE, the process proceeds to step 1650. In step 1650, the HIBERNATE state is to be maintained as the currently active state while the RF power available at the receiver module is below a certain predetermined level. When RF power remains unavailable or insufficient at the receiver module, the process proceeds to step 1645. When RF power is sufficiently available at the receiver module, the process proceeds to step 1655 and the receiver module enters the CHARGE state (see steps 1625, 1630, 1635, and 1640).

Returning to step 1620, when the next state of operation is RUN, the process proceeds to step 1670. In step 1670, the time that the light-emitting devices are ON in the illumination device is continuously updated. When the time during which the light-emitting devices are ON exceeds the run time or time interval determined during the CHARGE state, the process proceeds to step 1685 and the light-emitting devices are turned OFF. Following step 1685, in step 1690, the receiver module enters the CHARGE state (see steps 1625, 1630, 1635, and 1640). Returning to step 1670, when the time during which the light-emitting devices are ON does not exceed the run time or time interval determined during the CHARGE state, the process proceeds to step 1675. A minimum power-storage-module voltage (e.g., a voltage level threshold) can be set such that the power storage module is not completely drained (e.g., fully discharged). In step 1675, when the minimum or threshold power-storage-module voltage level is reached, the process proceeds to steps 1685 and 1690 described above. When the minimum or power-storage-module voltage threshold is not reached, the process proceeds to step 1680 in which the receiver module monitors a signal indicating to turn OFF the illumination device. When a signal is received and/or detected indicating to the receiver module to turn OFF the illumination device, the process proceeds to steps 1685 and 1690. Otherwise the process returns back to step 1670. After steps 1640, 1655, and 1690, the receiver module enters the low power SLEEP state until the periodic interval associated with the SLEEP state is exceeded.

FIG. 21 is a flow chart of the operation of a receiver module in an illumination device having a variable distance to a transmitter module and in which the capacity of a power storage module is determined. In step 1700, the receiver module in the illumination device is periodically awakened from the low power SLEEP state, at which point the illumination device's operation is initiated. In step 1702, the RF power available to the receiver module is measured. In this regard, the RF power need not be measured directly but can be determined based on the amount of DC power or charge current produced by the RF-to-DC conversion operation. When no RF power is available, it is desirable to minimize the amount of charge that is used from the power storage module. In step 1704, when insufficient or no RF power is available at the receiver module, the process proceeds to step 1706 and the receiver module enters the HIBERNATE state or remains in the HIBERNATE state if it is the current active state. When sufficient RF power is available at the receiver module, the process proceeds to step 1708. In step 1708, the receiver module determines the next state of operation based on the measured amount of RF power available. When the next state of operation is CHARGE, the process proceeds to step 1720. When the next state of operation is HIBERNATE, the process proceeds to step 1740. When the next state of operation is RUN, the process proceeds to step 1750.

In step 1720, because the distance and orientation between the transmitter module and the receiver module can change, the receiver module updates the power storage module capacity (e.g., total available stored DC power in milliamp-hours (mAh)) based on information associated with the RF power available at the receiver module and the total time during which the light-emitting devices of the illumination devices are or have been ON. In step 1722, while the power storage module is being charged, a trigger event to turn ON the receiver module is monitored. When a trigger event to turn ON the receiver module is not detected, the receiver module remains in step 1722. When a trigger event to turn ON the receiver module is detected, the process proceeds to step 1724.

In step 1724, the receiver module determines a run time or time interval to operate the illumination device. A predetermined run time or time interval to operate the illumination device can be used but may be adjusted to account for changes in the distance between the receiver module and the transmitter module. In some instances, the run time can be reduced based on, for example, an inadequate charging time or the power-storage-module voltage level indicating that the available capacity of the power storage module is not sufficient to operate the illumination device for the entire run time. In step 1726, after the run time or time interval is determined and/or adjusted, the receiver module allows for the light-emitting devices in the illumination device to turn ON. In step 1728, the receiver module enters the RUN state as described in step 1708 and implemented beginning at step 1750.

Returning to step 1708, when the next state of operation is HIBERNATE, the process proceeds to step 1740. In step 1740, the HIBERNATE state is to be maintained as the currently active state while the RF power available at the receiver module is below a certain predetermined level. When RF power remains unavailable or insufficient at the receiver module, the process proceeds to step 1740. When RF power is sufficiently available at the receiver module, the process proceeds to step 1742 and the receiver module enters the CHARGE state (see steps 1720, 1722, 1724, 1726, and 1728).

Returning to step 1708, when the next state of operation is RUN, the process proceeds to step 1750. In step 1750, because the distance and/or orientation between the transmitter module and the receiver module can vary, the receiver module updates the power storage module capacity (e.g., stored DC power) based on information associated with the received RF power, the charging current to the power storage module, the amount of DC current used by the light-emitting devices, and/or the time during which the light-emitting devices have been operating (e.g., elapsed time). In step 1752, the receiver module updates the run time or time interval during which the light-emitting devices are ON in the illumination device based on the power-storage-module capacity.

In step 1754, when the time during which the light-emitting devices are ON exceeds the run time or time interval determined during the CHARGE state, the process proceeds to step 1760 and the light-emitting devices are turned OFF. Following step 1760, in step 1762, the receiver module enters the CHARGE state. Returning to step 1754, when the time during which the light-emitting devices are ON does not exceed the run time or time interval determined during the CHARGE state, the process proceeds to step 1756. In step 1756, a minimum power-storage-module voltage can be set such that the power storage module is not completely drained. When the minimum or threshold power-storage-module voltage level is reached, the process proceeds to steps 1760 and 1762 described above. When the minimum or power-storage-module voltage threshold is not reached, the process proceeds to step 1758 in which the receiver module monitors a signal indicating to turn OFF the illumination device. When a signal is received and/or detected indicating to the receiver module to turn OFF the illumination device, the process proceeds to steps 1760 and 1762. Otherwise, the process returns back to step 1754. After steps 1728, 1742, and 1762, the receiver module enters the low power SLEEP state until the periodic interval associated with the SLEEP state is exceeded.

In one embodiment, a receiver module, such as the receiver module 1500 in FIG. 19, for example, can be configured to determine a run time or active time interval for a device. The receiver module is configured to measure a received DC power by sensing or measuring a voltage or current on a known load resistance and determining a value of a current recharging a power storage module (e.g., battery). The sensing or measuring operation can be performed periodically, continuously, and/or while a device being powered by the receiver module is active (e.g., LED is illuminated). Based on the value of the recharging current, the receiver module can estimate a time interval during which the device can be active and still allow the receiver module to recharge the power storage element to a desired level in a given recharge period. The time interval can be estimated by the following expression:

run time=recharge current*recharge time/active current,

where “run time” refers to the time the device is to be active, “recharge current” is the value of the recharging current, “recharge time” is the time during which the device is inactive, and “active current” is a value of the current used while the device is active. As an example, if the recharge time is 24 hours (hrs), the active current is 10 mA, and the recharge current is 1 mA, the run time or time interval is 2.4 hrs in a 24-hour period. The receiver module can operate such that the 2.4 hrs is a continuous time interval or not. In some instances, the receiver module may not operate the device over the complete 2.4 hrs available. This example is based on sleep current of the device being sufficiently small that it can be neglected. If the sleep current of the device cannot be neglected, the run time may be shorter in duration than the 2.4 hrs calculated. In this regard, the sleep current is subtracted from the recharging current in the run time calculation above. It should be noted that the recharging current can vary with time, particularly when the device to be powered is a mobile device. In such instances, the receiver module can determine the average power or recharging current over the recharge time when determining the run time. The average power or recharging current can be determined by, for example, adding the measured values and dividing by the number of samples. It should be noted that the device may or may not recharge during the run time.

An illumination device, such as a decorative lighting product, for example, can have a run time for operation light-emitting devices that is adjusted to ensure that the illumination device can recharge in a 24-hour period. In this regard, the run time or active time interval is calculated by measuring a voltage across a sampling resistor. The voltage is proportional to the received DC power. In one example, a processor within the receiver module can access a look-up table, for example, to determine the recharge current from the measured voltage. In another example, the processor can determine the recharge current based on multiple voltage samples. The recharge current and/or DC power is inversely proportional to the distance between the receiver module and the transmitter module. Therefore, the illumination device can have longer run time or active time interval when it is placed closer to the transmitter module than when it is placed further from the transmitter module. The illumination device in this embodiment, however, is capable of operating when the receiver module is in a range of up to eight feet from the transmitter module.

In another embodiment, a receiver module, such as the receiver module 1500 in FIG. 19, for example, can be used to determine a recharge time for a battery. The device being powered by the receiver module can be, for example, a wireless sensor where the active period of operation has a fixed duration and uses a fixed amount of current. For example, a wireless temperature sensor can actively sense for 40 milliseconds (ms) and use 40 mA to operate and transfer data back to a base station. In this instance, the recharging current is approximately 300 μA. The recharge time can be estimated by the following expression:

recharge time=40 mA*40 ms/300 μA=5.33 seconds,

such that a receiver module having a temperature sensor can send a temperature reading to a base station every 5.33 seconds and have sufficient charge (e.g., stored DC power) to continue to operate. The recharge time can be adjusted to account for a non-negligible sleep current in the temperature sensor.

In another embodiment, a receiver module, such as the receiver module 1500 in FIG. 19, for example, can determine an active current for a device to be operated by the receiver module. For example, an illumination device (e.g., light stick) can have the periods of activity and inactivity of the LEDs (e.g., duty cycle) adjusted by controlling an LED driver. In this instance, the illumination device can have a fixed or constant run time, however, the current provided to the LEDs could vary when the distance between the illumination device and the transmitted module changed. For example, while the illumination provided by the LEDs is reduced as the distance between the illumination device and the transmitter module is increased, the run time of the LEDs does not change when the distance between the illumination device and the transmitter module is increased. Similarly, while the illumination provided by the LEDs is increased as the distance between the illumination device and the transmitter module is reduced, the run time of the LEDs does not change when the distance between the illumination device and the transmitter module is reduced.

In another embodiment, to increase the operating life of a power storage module, a receiver module, such as the receiver module 1500 in FIG. 19, for example, is configured to monitor the power-storage-module voltage level to ensure that the voltage level does not fall below a predetermined threshold level. In this manner, the operating life of the power storage module can be increased by avoiding deep (e.g., below the threshold level) discharges. The receiver module can disable a device operating from the charge or DC power stored in the power storage module until a voltage level is reached above the threshold level.

It should be noted that with any of the embodiments described above, when the receiver module does not receive sufficient power to actively operate a device, the device remains in sleep mode (e.g., disabled) until a sufficient amount of charge is stored to operate the device. In any of the above embodiments, the receiver module can have an indicator to indicate the level of any parameter associated with the receiver module. As an example, a light indicator can be used to provide a user with a visual indication of the run time available.

It should be noted that in some of the above embodiments a trigger source or trigger device can be included to produce or detect a trigger event for activating or initiating the active period or active mode of a device. The trigger devices can include, for example, one or more of the following: light sensor, user interaction, switch, motion sensor, timer, microprocessor or microprocessor code, voltage monitoring chip, gas gauge chip, or any other device capable of activating a device. As an example, a user may press a button on the transmitter module that toggles (e.g., ON/OFF) the RF power being sent from the transmitter module to the receiver module such that a device to be powered by the receiver module starts to operate in its active mode. As another example, a light sensor detects when, for example, the sun has gone down and the light or illumination level in a room is below a threshold level such that the LEDs in a light stick are turned ON. Yet another example, a software-based timer operates such that a temperature reading is performed at various time instances. The receiver module is configured to dynamically adjust or update the software-based timer interval to ensure enough charge is captured before a next measurement reading is to be performed.

### Conclusion

While various embodiments have been described above, it should be understood that they have been presented by way of example only, and not limitation. For example, the wireless power transmitter and/or the wireless power receiver described herein can include various combinations and/or sub-combinations of the components and/or features of the different embodiments described. Although described with reference to use with a particular wireless power transmitter, it should be understood that a wireless power receiver can be used with multiple and/or different power transmitters, and/or with multiple and/or different sources of electromagnetic waves. Moreover, the wireless power transmitter can be used to provide DC power to devices, other than light-emitting devices, having periods of activity and periods of inactivity.

In some embodiments, a wireless power receiver can be configured such that the charging or storing of DC power in a power storage module can occur at the same time as a device (e.g., an LED) receives stored DC power from the power storage module. In another embodiment, the wireless power receiver can be configured to charge and/or discharge more than one power storage module.

Some embodiments include a processor and a related processor-readable medium having instructions or computer code thereon for performing various processor-implemented operations. Such processors can be implemented as hardware modules such as embedded microprocessors, microprocessors as part of a computer system, Application-Specific Integrated Circuits (“ASICs”), and Programmable Logic Devices (“PLDs”). Such processors can also be implemented as one or more software modules in programming languages as Java, C++, C, assembly, a hardware description language, or any other suitable programming language.

A processor according to some embodiments includes media and computer code (also can be referred to as code) specially designed and constructed for the specific purpose or purposes. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as optical disks, and read-only memory (“ROM”) and random-access memory (“RAM”) devices. Examples of computer code include, but are not limited to, micro-code or micro-instructions, machine instructions, such as produced by a compiler, and files containing higher-level instructions that are executed by a computer using an interpreter. For example, an embodiment of the invention can be implemented using Java, C++, or other object-oriented programming language and development tools. Additional examples of computer code include, but are not limited to, control signals, encrypted code, and compressed code.

What is claimed is:

1. An apparatus, comprising:
a member;
a first elongate member and a second elongate member, each of the first elongate member and the second elongate member being coupled to the member;
a receiver configured to convert an electromagnetic wave to a DC power, the receiver being disposed on the member; and
a first light-emitting device and a second light-emitting device, each of the first light-emitting device and the second light-emitting device configured to operate based on the DC power from the receiver, the first light-emitting device being disposed on the first elongate member, the second light-emitting device being disposed on the second elongate member.

2. The apparatus of claim 1, wherein the receiver is disposed on a first end portion of the member, and the first elongate member and the second elongate member are coupled to a second end portion of the member opposite the first end portion.

3. The apparatus of claim 1, wherein a proximal end portion of the first elongate member and a proximal end portion of the second elongate member are coupled to a second end portion of the member.

4. The apparatus of claim 1, wherein the receiver includes an antenna and a converter, the converter configured to convert the electromagnetic wave received through the antenna into the DC power.

5. The apparatus of claim 1, wherein the receiver includes a power storage element to store energy associated with the DC power.

6. The apparatus of claim 1, wherein the receiver is configured to disable the operation of the first light-emitting device and the second light-emitting device when the receiver detects a predetermined event

7. The apparatus of claim 1, wherein the receiver is configured to disable the operation of the first light-emitting device and the second light-emitting device when the receiver detects at least one of the following:
a predetermined environmental illumination level,
an appropriate control signal, or
a predetermined operation duration.

8. The apparatus of claim 1, wherein at least one of the first light-emitting device or the second light-emitting device is a light-emitting diode.

9. The apparatus of claim 1, wherein a length of at least one of the first elongate member or the second elongate member is between about 6 inches and about 24 inches.

10. The apparatus of claim 1, wherein a length of the member is between about 6 inches and about 24 inches.

11. The apparatus of claim 1, wherein a distance between the receiver and at least one of the first light-emitting device or the second light-emitting device is between about 6 inches and about 48 inches.

12. The apparatus of claim 1, wherein a distance between the first light-emitting device and the second light-emitting device is between about 1 inch and about 24 inches.

13. The apparatus of claim 1, wherein the receiver is a first receiver, the apparatus further comprising:
a second receiver configured to convert an electromagnetic wave to a DC power, the second receiver being disposed on the first elongate member;
wherein the first light-emitting device and the second light-emitting device are configured to operate based on at least one of the DC power from the first receiver or the DC power from the second receiver.

14. The apparatus of claim 1, wherein the receiver is a first receiver, the apparatus further comprising:
a second receiver configured to convert an electromagnetic wave to a DC power, the second receiver being disposed on the first elongate member;
wherein the first light-emitting device and the second light-emitting device are configured to operate based on at least one of the DC power from the first receiver or the DC power from the second receiver;
wherein the first receiver is disposed on a first end portion of the member, a first end portion of the first elongate member is coupled to a second end portion of the member opposite the first end portion of the member, the second receiver is disposed on a second end portion of the first elongate member opposite the first end portion of the first elongate member.

15. The apparatus of claim 1, wherein the receiver is a first receiver, the apparatus further comprising:
a second receiver configured to convert an electromagnetic wave to a DC power, the second receiver being disposed on the first elongate member;
wherein the first light-emitting device and the second light-emitting device are configured to operate based on at least one of the DC power from the first receiver or the DC power from the second receiver;
wherein a distance between the first receiver and the second receiver is between about 6 inches and about 48 inches.

16. The apparatus of claim 1, further comprising a driver configured to adjust the DC power from the receiver to provide at least one of a substantially constant current or a substantially constant voltage to the first light-emitting device and to the second light-emitting device.

17. An apparatus, comprising:
a container including a receiver configured to convert an electromagnetic wave to a DC power;
a first elongate member having a first end portion being coupled to the container;
a second elongate member being coupled to a second end portion of the first elongate member opposite the first end portion; and
a light-emitting device configured to operate based on the DC power from the receiver, the light-emitting device being disposed on the second elongate member.

18. The apparatus of claim 17, further comprising a driver configured to adjust the DC power from the receiver to provide at least one of a substantially constant current or a substantially constant voltage to the light-emitting device.

19. The apparatus of claim 17, wherein a length of at least one of the first elongate member or the second elongate member is between about 6 inches and about 24 inches.

20. The apparatus of claim 17, wherein the light-emitting device is a light-emitting diode.

21. An apparatus, comprising:
a first elongate member and a second elongate member, the second elongate member being coupled to the first elongate member;
a receiver configured to convert an electromagnetic signal to a DC power, the receiver being disposed on the first elongate member; and
a light-emitting device configured to operate based on the DC power from the receiver, the light-emitting device being disposed on the second elongate member.

22. The apparatus of claim 21, wherein the receiver is a first receiver, the apparatus further comprising:
a third elongate member coupled to the first elongate member;
a second receiver configured to convert an electromagnetic signal to a DC power, the second receiver being disposed on the third elongate member, the DC power from the first receiver and the DC power from the second receiver configured to a DC power bus; and
a driver configured to adjust the DC power bus to provide at least one of a substantially constant current or a substantially constant voltage to the light-emitting device.

23. The apparatus of claim 21, wherein the light-emitting device is a light-emitting diode.

24. The apparatus of claim 21, wherein the receiver is a first receiver, the light-emitting device is a first light-emitting device, further comprising:
a second receiver configured to convert an electromagnetic signal to a DC power, the second receiver being disposed on the second elongate member; and
a second light-emitting device being disposed on the first elongate member, the first light-emitting device configured to operate based on the DC power from the second receiver, the second light-emitting device configured to operate based on the DC power from the first receiver.

25. The apparatus of claim 21, wherein the receiver is a first receiver, the light-emitting device is a first light-emitting device, further comprising:
a second receiver configured to convert an electromagnetic signal to a DC power, the second receiver being disposed on the second elongate member; and
a second light-emitting device being disposed on the first elongate member, the first light-emitting device configured to operate based on the DC power from the second receiver, the second light-emitting device configured to operate based on the DC power from the first receiver;
wherein a distance between the first receiver and the second receiver is between about 6 inches and about 24 inches.

26. An apparatus, comprising:
a first elongate member and a second elongate member, a first end portion of the first elongate member coupled to a first end portion of the second elongate member;
a receiver configured to convert an electromagnetic wave to a DC power, the receiver being disposed on the first elongate member; and
a first light-emitting device and a second light-emitting device, each of the first light-emitting device and the second light-emitting device configured to operate based on the DC power from the receiver, the first light-emitting device being disposed on a second end portion of the first elongate member opposite the first end portion of the first elongate member, the second light-emitting device being disposed on a second end portion of the second elongate member opposite a first end portion of the second elongate member.

27. A method, comprising:
receiving an electromagnetic wave;
converting the electromagnetic wave to a DC power;
providing the DC power to a light-emitting device; and
disabling the operation of the light-emitting diode based a predetermined event.

28. The method of claim 27, wherein the predetermined event is at least one of a predetermined illumination level, an appropriate control signal, or an expiration of a time period.

29. The method of claim 27, further comprising adjusting the DC power based on at least one of a type or a number of light-emitting devices to be powered by the DC power.

30. The method of claim 27, further comprising storing the DC power when the operation of the light-emitting device is disabled.

31. A kit, comprising:
a transmitter configured to generate an electromagnetic wave;
a receiver configured to convert the electromagnetic wave to a DC power; and
an elongate member having a first end portion and a second end portion opposite the first end portion, the receiver being disposed on the first end portion of the elongate member, a light-emitting device being disposed on the second end portion of the elongate member, the light-emitting device configured to operate based on the DC power from the receiver.

32. The kit of claim 31, wherein the receiver is a first receiver, the elongate member is a first elongate member, the light-emitting device is a first light-emitting device, the kit further comprising:
a second receiver configured to convert the electromagnetic wave to a DC power; and
a second elongate member having a first end portion and a second end portion opposite the first end portion, the second receiver being disposed on the first end portion of the second elongate member, a second light-emitting device being disposed on the second end portion of the second elongate member, the second light-emitting device configured to operate based on the DC power from the second receiver.

33. The kit of claim 31, wherein the elongate member is a first elongate member, the light-emitting device is a first light-emitting device, the kit further comprising:
a second elongate member; and
a second light-emitting device being disposed on the second elongate member, the second light-emitting device configured to operate based on the DC power from the receiver.
